(19) United States
(12) Patent Application Publication
(10) Pub. No.: US 2024/0064770 A1
(43) Pub. Date: Feb. 22, 2024

(54) DCI BASED DL TCI STATE AND UL TCI STATE ACTIVATION

(71) Applicant: Telefonaktiebolaget LM Ericsson (publ), Stockholm (SE)

(72) Inventors: Claes Tidestav, Bålsta (SE); Andreas Nilsson, Göteborg (SE); Siva Muruganathan, Stittsville (CA); Helka-Liina Määttänen, Espoo (FI)

(21) Appl. No.: 18/270,517

(22) PCT Filed: Dec. 30, 2021
(86) PCT No.: PCT/IB2021/062483

§ 371 Date: Jun. 30, 2023

Related U.S. Application Data
(60) Provisional application No. 63/132,122, filed on Dec. 30, 2020.

(51) Int. Cl. H04W 72/232; H04W 76/20

(52) U.S. Cl. CPC H04W 72/232; H04W 76/20

(57) ABSTRACT

Systems and methods of the present disclosure are directed to a method performed by a wireless communication device (WCD). The method includes receiving, from a network node, downlink control information (DCI) that includes information that indicates Transmission Configuration Indicator (TCI) state(s) to be activated at the WCD. The TCI state(s) to be activated at the WCD include downlink TCI state(s), uplink TCI state(s), or both. The method includes updating a list of activated downlink TCI states at the WCD, a list of activated uplink TCI states at the WCD, or both the list of activated downlink TCI states and the list of activated uplink TCI states at the WCD based on the received DCI.

### RELATED APPLICATIONS

This application claims the benefit of provisional patent application Ser. No. 63/132,122, filed Dec. 30, 2020, the disclosure of which is hereby incorporated herein by reference in its entirety.

### TECHNICAL FIELD

The present disclosure relates to updating Transmission/Configuration Indicator states and, more specifically, utilization of Downlink Control Information (DCI) to update a list of activated DL TCI states and/or UL TCI states.

### BACKGROUND

### New Radio (NR)

The Fifth Generation (5G) mobile wireless communication system or New Radio (NR) supports a diverse set of use cases and a diverse set of deployment scenarios.

NR uses Cyclic Prefix Orthogonal Frequency Division Multiplexing (OFDM), or CP-OFDM, in the downlink (i.e., from a network node, gNB, eNB, or base station, to a user equipment or UE) and both CP-OFDM and Discrete Fourier Transform (DFT)-spread OFDM, or DFT-S-OFDM, in the uplink (i.e., from UE to gNB). In the time domain, NR downlink and uplink physical resources are organized into equally-sized subframes of 1 millisecond (ms) each. A subframe is further divided into multiple slots of equal duration.

The slot length depends on subcarrier spacing. For subcarrier spacing of Δf=15 kHz, there is only one slot per subframe and each slot always consists of 14 OFDM symbols, irrespectively of the subcarrier spacing. FIG. 1 illustrates the NR time-domain structure with 15 kHz subcarrier spacing.

Typical data scheduling in NR are per slot basis. An example is shown in FIG. 1 where the first two symbols contain Physical Downlink Control Channel (PDCCH) and the remaining twelve symbols contain Physical Data Channel (PDCH), either a Physical Downlink Shared Channel (PDSCH) or a Physical Uplink Shared Channel (PUSCH).

Different subcarrier spacing values are supported in NR. The supported subcarrier spacing values (also referred to as different numerologies) are given by Δf=(15×2^{α}) kHz where a is a non-negative integer. Δf=15 kHz is the basic subcarrier spacing that is also used in Long Term Evolution (LTE). The slot durations at different subcarrier spacings are shown in Table 1.

TABLE 1
Slot length at different numerologies.

| Numerology | Slot length | RB BW |
|---|---|---|
| 15 KHZ | 1 ms | 180 KHz |
| 30 KHz | 0.5 ms | 360 KHz |
| 60 KHz | 0.25 ms | 720 KHz |
| 120 KHz | 125 μs | 1.44 MHz |
| 240 KHz | 62.5 μs | 2.88 MHz |

In the frequency-domain physical resource definition, a system bandwidth is divided into Resource Blocks (RBs), each corresponding to twelve contiguous subcarriers. The Common RBs (CRBs) are numbered starting with 0 from one end of the system bandwidth. The UE is configured with one or up to four bandwidth parts (BWPs), which may be a subset of the RBs supported on a carrier. Hence, a BWP may start at a CRB larger than zero. All configured BWPs have a common reference, which is the CRB 0. Hence, a UE can be configured a narrow BWP (e.g., 10 Megahertz (MHz)) and a wide BWP (e.g., 100 MHz), but only one BWP can be active for the UE at a given point in time. The Physical RBs (PRB) are numbered from 0 to N−1 within a BWP, but note that the 0:th PRB of a BWP may be the K:th CRB where K>0.

FIG. 2 illustrates a basic NR physical time-frequency resource grid, where only one RB within a 14-symbol slot is shown. One OFDM subcarrier during one OFDM symbol interval forms one Resource Element (RE).

Downlink transmissions can be dynamically scheduled, i.e., in each slot the gNB transmits Downlink Control Information (DCI) over PDCCH about which UE data is to be transmitted to and which RBs in the current downlink slot the data is transmitted on. PDCCH is typically transmitted in the first one or two OFDM symbols in each slot in NR. The UE data is carried on PDSCH. A UE first detects and decodes PDCCH and, if the decoding is successful, it then decodes the corresponding PDSCH based on the decoded DCI in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

### QCL and TCI States

In NR, several signals can be transmitted from different antenna ports of a same base station. These signals can have the same large-scale properties such as Doppler shift/spread, average delay spread, or average delay. These antenna ports are then said to be Quasi Co-Located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a Channel State Information Reference Signal (CSI-RS) for Tracking RS (TRS) and the PDSCH Demodulation Reference Signal (DMRS). When UE receives the PDSCH DMRS, the UE can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same receive (Rx) beam to receive them. This is helpful for a UE that uses analog beamforming to receive signals, since the UE needs to adjust its Rx beam in some direction prior to receiving a certain signal. If the UE knows that the signal is spatially QCL with some other signal it has received earlier, then it can safely use the same Rx beam to also receive this signal. Note that for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a CSI-RS for tracking (TRS) for time/frequency offset estimation. To be able to use any QCL reference, the UE would have to receive it with a sufficiently good Signal to Interference plus Noise Ratio (SINR). In many cases, this means that the TRS must be transmitted in a suitable beam to a certain UE.

To introduce dynamics in beam and Transmission and Reception point (TRP) selection, the UE can be configured through Radio Resource Control (RRC) signaling with up to 128 Transmission Configuration Indicator (TCI) states. FIG. 3 illustrates the TCI state information element as defined in Third Generation Partnership Project (3GPP) Technical Specification (TS) 38.331 V16.2.0.

Each TCI state contains QCL information related to one or two RSs. For example, a TCI state may contain CSI-RS1 associated with QCL Type A and CSI-RS2 associated with QCL TypeD. If a third RS, e.g. the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates, via a Medium Access Control (MAC) Control Element (CE), one TCI state for PDCCH (i.e., provides a TCI for PDCCH) and up to eight TCI states for PDSCH. The number of active TCI states that the UE supports is a UE capability, but the maximum in the current NR specifications is eight.

Assume a UE has four activated TCI states (from a list of 64 configured TCI states). Hence, sixty TCI states are inactive for this particular UE, and the UE needs not be prepared to have large scale parameters estimated for those inactive TCI states. But the UE continuously tracks and updates the large-scale parameters for the RSs in the four active TCI states. When scheduling a PDSCH to a UE, the DCI contains a pointer to one activated TCI state. The UE then knows which large-scale parameter estimate to use when performing PDSCH DMRS channel estimation and thus PDSCH demodulation.

As long as the UE can use any of the currently activated TCI states, it is sufficient to use DCI signaling. However, at some point in time, none of the RSs in the currently activated TCI states can be received by the UE, i.e., when the UE moves out of the beams in which the RSs in the activated TCI states are transmitted. When this happens (or actually before this happens), the gNB would have to activate new TCI states. Typically, since the number of activated TCI states is fixed, the gNB would also have to deactivate one or more of the currently activated TCI states.

FIG. 4 depicts a two-step procedure related to TCI state update. As illustrated, when an update to the current TCI state is needed, a new TCI state is selected with DCI. If a new set of TCIs states needs to be activated, the gNB activates new TCI states for the UE using a MAC CE.

### TCI States Activation/Deactivation for UE-Specific PDSCH Via MAC CE

Now the details of the MAC CE signaling that is used to activate/deactivate TCI states for UE specific PDSCH are provided. FIG. 5 illustrates the structure of the MAC CE for activating/deactivating TCI states for UE specific PDSCH.

As shown in FIG. 5, the MAC CE contains the following fields:
Serving Cell ID: This field indicates the identity of the Serving Cell for which the MAC CE applies. The length of the field is 5 bits;
BWP ID: This field contains the ID corresponding to a downlink bandwidth part for which the MAC CE applies. The BWP ID is given by the higher layer parameter BWP-Id as specified in Third Generation Partnership Program (3GPP) Technical Specification (TS) 38.331, NR; RRC; Protocol specification, v. 16.2.0 (10-2020). The length of the BWP ID field is 2 bits since a UE can be configured with up to 4 BWPs for downlink;
A variable number of fields Tᵢ: If the UE is configured with a TCI state with TCI State ID I, then then the field Tᵢ indicates the activation/deactivation status of the TCI state with TCI State ID i. If the UE is not configured with a TCI state with TCI State ID 4 the MAC entity shall ignore the Tᵢ field. The Tᵢ field is set to ““ ”” to indicate that the TCI state with TCI State ID i shall be activated and mapped to the codepoint of the DCI Transmission Configuration Indication field, as specified in 3GPP TS 38.214, Physical layer procedures for data, v. 16.1.0. (04-2020). The Tᵢ field is set to “0” to indicate that the TCI state with TCI State ID i shall be deactivated and is not mapped to the codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to ‘0’ in NR Rel-15.

Note that the TCI States Activation/Deactivation for UE-specific PDSCH MAC CE is identified by a MAC PDU subheader with Logical Channel ID (LCID) as specified in Table 6.2.1-1 of 3GPP TS 38.321, NR; MAC protocol specification, V16.0.0 (04-2020). The MAC CE for Activation/Deactivation of TCI States for UE-specific PDSCH has variable size.

### TCI State Indication for UE-Specific PDSCH via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if td-PresentInDCI is “enabled” or td-PresentForDCI-Format1-2-r16 is present respectively for DCI format 1_1 and DCI 1_2 by higher layer. FIG. 6 illustrates an example of such a DCI indication of a TCI state.

DCI code point 0 indicates the first TCI state index in the list of TCI states, DCI code point 1 indicates the second TCI state index in the list, and so on.

### DCI Based Activation of TCI States

Explicitly activating one or a group of TCI states using DCI is known.

### Multi-TRP TCI State Operation

In NR Release 16, a multi-TRP (multiple-transmission reception point) operation was specified and it has two modes of operation, single DCI based multi-TRP and multiple DCI based multi-TRP.

In NR Release 16, multiple DCI scheduling is for multi-TRP in which a UE may receive two DCIs each scheduling a PDSCH/PUSCH. Each PDCCH and PDSCH are transmitted from the same TRP.

For multi-DCI multi-TRP operation, a UE needs to be configured with two CORESET pools, each associated with a TRP. Each CORESET pool is a collection of CORESETs that belongs to the same CORESET pool. A CORESET pool index can be configured in each CORESET with a value of 0 or 1. For the two DCIs in the above example, they are transmitted in two CORESETs belonging to different CORESET pools (i.e., with CORESETPoolIndex 0 and 1 respectively). For each CORESET Pool, the same TCI state operation method in terms of activation/deactivation/indication is used as is described above for single TRP operation.

The other multi-TRP mode, single DCI based multi-TRP, needs two DL TCI states to be associated to one DCI codepoint. That is, when a TCI field codepoint in DCI indicates two TCI states, each TCI state corresponding to a different beam or different TRP. The activation and mapping of 2 TCI states for a codepoint in the TCI field of DCI is done with the below MAC CE from 3GPP TS 38.321:

### Begin Excerpt from 3GPP TS 38.321 V16.0.0 (04-2020)

6.1.3.24 Enhanced TC1 States Activation/Deactivation for UE-specific PDSCH MAC CE The Enhanced TCI States Activation/Deactivation for UE-specific PDSCH MAC CE is identified by a MAC PDU subheader with eLCID as specified in Table 6.2.1-1b. It has a variable size consisting of following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in TS 38.212 [9]. The length of the BWP ID field is 2 bits;
Cᵢ: This field indicates whether the octet containing TCI state ID_{i,2} is present. If this field is set to “1”, the octet containing TCI state ID_{i,2} is present. If this field is set to “0”, the octet containing TCI state ID_{i,2} is not present;
TCI state ID_{i,j}: This field indicates the TCI state identified by TCI-StateId as specified in TS 38.331 [5], where i is the index of the codepoint of the DCI Transmission configuration indication field as specified in TS 38.212 [9] and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID_{0,1} and TCI state ID_{0,2} shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2.
R: Reserved bit, set to “0”.

### FIG. 6.1.3.24-1: Enhanced TCI States Activation/Deactivation for UE-Specific PDSCH MAC CE

### Reproduced Herein as FIG. 30

### End Excerpt from 3GPP TS 38.321 V16.0.0 (04-2020)

### Inter-Cell Multi-TRP Operation

In NR Rel-17, Inter-cell multi-TRP operation is to be specified. This is an extension of either single DCI based multi-TRP or multiple DCI based multi-TRP operation of Release 16. The intercell aspect of Rel-17 refers to the case when the two TRPs are associated to different SSBs associated with different PCIs (Physical Cell IDs). That is, the TCI state that refers to transmission from TRP 1 or TRP 2 is quasi-collocated to a reference signal that is either one of the SSB beams with the PCI belonging to that TRP, or another reference signal like CSI-RS or DMRS that has root quasi-collocation assumption to one of the SSB beams with PCI belonging to that TRP.

### SUMMARY

Embodiments of a method performed by a wireless communication device (WCD) are disclosed. In one embodiment, the method includes receiving, from a network node, Downlink Control Information (DCI) that comprises information indicates one or more Transmission/Configuration Indicator (TCI) states to be activated at the WCD. The one or more TCI states to be activated at the WCD comprise one or more Downlink (DL) TCI states to be activated at the WCD, one or more Uplink (UL) TCI states to be activated at the WCD, or both one or more DL TCI states to be activated at the WCD and one or more UL TCI states to be activated at the WCD. The method further comprises updating a list of activated DL TCI states at the WCD, a list of activated UL TCI states at the WCD, or both the list of activated DL TCI states and the list of activated UL TCI states at the WCD, based on the received DCI. Thus, embodiments of the present disclosure may speed up and simplify TCI state selection for DL channels/signals and/or UL channels/signals, since MAC CE based signaling can be avoided.

In one embodiment, for each TCI state of the one or more TCI states to be activated at the WCD, the DCI further includes information that indicates whether the TCI state is an DL TCI state or an UL TCI state. In another embodiment, for each TCI state of the one or more TCI states to be activated at the WCD, the DCI further includes information that indicates whether the TCI state is an DL TCI state, an UL TCI state, or both a DL TCI state and an UL TCI state.

In one embodiment, the one or more TCI states to be activated at the WCD 712 are to be mapped to a particular one of a plurality of codepoints of a TCI field in a DCI, and the DCI further comprises information that indicates the particular one of the plurality of codepoints. In another embodiment, for each TCI state of the one or more TCI states to be activated at the WCD, the DCI further comprises information that indicates one of a plurality of codepoints of a TCI field in a DCI to which the TCI state is to be mapped.

In one embodiment, the one or more TCI states to be activated at the WCD comprises a DL TCI state and an UL TCI state, and the DCI includes a first field for indication of a DL TCI state that comprises a TCI index of the DL TCI state to be activated at the WCD and a second field for indication of an UL TCI state that comprises a TCI index of the DL TCI state to be activated at the WCD. In one embodiment, the DCI further includes a third field that comprises information that indicates one of plurality of codepoints of a TCI field of a DCI to which the DL TCI state and the UL TCI state are to be mapped. In one embodiment, the DCI further includes a third field that comprises information that indicates a first one of plurality of codepoints of a TCI field of a DCI to which the DL TCI state is to be mapped and a fourth field that comprises information that indicates a second one of plurality of codepoints of the TCI field to which the UL TCI state is to be mapped.

In one embodiment, the one or more TCI states to be activated at the WCD 712 are one of two or more groups of TCI states, and the information comprised in the DCI that indicates the one or more TCI states is information that indicates the one of the two or more groups of TCI states. In one embodiment, the two or more groups of TCI states are configured by the network.

In one embodiment, a DCI format of the received DCI indicates whether the one or more TCI states to be activated at the WCD are one or more DL TCI states or one or more UL TCI states. In another embodiment, a DCI format of the received DCI indicates whether the one or more TCI states to be activated at the WCD are one or more DL TCI states, one or more UL TCI states, or both DL and UL TCI states. In another embodiment, a Radio Network Temporary Identifier (RNTI) of the received DCI indicates whether the one or more TCI states to be activated at the WCD are one or more DL TCI states or one or more UL TCI states. In another embodiment, an RNTI of the received DCI indicates whether the one or more TCI states to be activated at the WCD are one or more DL TCI states, one or more UL TCI states, or both DL and UL TCI states.

In one embodiment, the one or more TCI states to be activated at the WCD comprises two or more DL TCI states for a single codepoint of a TCI field of DCI, two or more UL TCI states for a single codepoint of the TCI field, or both two or more DL TCI states and two or more UL TCI states for a single codepoint of the TCI field. In another embodiment, the WCD maintains separate lists of activated DL and/or UL TCI states for two or more TRPs or two or more CORESET pools. In another embodiment, the WCD maintains separate lists of activated DL and/or UL TCI states for two or more Synchronization Signal Blocks (SSBs) and/or Physical Cell IDs (PCIs).

Corresponding embodiments of a WCD are also disclosed. In one embodiment, a WCD is adapted to receive, from a network node, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD. The WCD is further adapted to update a list of activated DL TCI states at the WCD, a list of activated UL TCI states at the WCD, or both the list of activated DL TCI states and the list of activated UL TCI states at the WCD, based on the received DCI.

In another embodiment, the WCD comprises one or more transmitters, one or more receivers, and processing circuitry. The processing circuitry is configured to cause the WCD to receive, from a network node, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD. The processing circuitry is further configured to cause the WCD to update a list of activated DL TCI states at the WCD, a list of activated UL TCI states at the WCD, or both the list of activated DL TCI states and the list of activated UL TCI states at the WCD, based on the received DCI.

Embodiments of a method performed by a network node are also disclosed. In one embodiment, the method comprises sending, to a WCD, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD.

In some embodiments, for each TCI state of the one or more TCI states to be activated at the WCD, the DCI further comprises information that indicates whether the TCI state is an DL TCI state or an UL TCI state. In some embodiments, for each TCI state of the one or more TCI states to be activated at the WCD, the DCI further comprises information that indicates whether the TCI state is an DL TCI state, an UL TCI state, or both a DL TCI state and an UL TCI state.

In some embodiments, the one or more TCI states to be activated at the WCD are to be mapped to a particular one of a plurality of codepoints of a TCI field in a DCI, and the DCI further comprises information that indicates the particular one of the plurality of codepoints.

In some embodiments, for each TCI state of the one or more TCI states to be activated at the WCD, the DCI further comprises information that indicates one of a plurality of codepoints of a TCI field in a DCI to which the TCI state is to be mapped

In some embodiments, the one or more TCI states to be activated at the WCD comprises a DL TCI state and an UL TCI state, and the DCI comprises a first field for indication of a DL TCI state that comprises a TCI index of the DL TCI state to be activated at the WCD and a second field for indication of an UL TCI state that comprises a TCI index of the UL TCI state to be activated at the WCD.

In some embodiments, the DCI further comprises a third field that comprises information that indicates one of plurality of codepoints of a TCI field of a DCI to which the DL TCI state and the UL TCI state are to be mapped.

In some embodiments, the DCI further comprises a third field that comprises information that indicates a first one of plurality of codepoints of a TCI field of a DCI to which the DL TCI state is to be mapped and a fourth field that comprises information that indicates a second one of plurality of codepoints of the TCI field to which the UL TCI state is to be mapped.

In some embodiments, the one or more TCI states to be activated at the WCD is one of two or more groups of TCI states, and the information comprised in the DCI that indicates the one or more TCI states is information that indicates the one of the two or more groups of TCI states.

In some embodiments, the method further comprises receiving, from a network node, information that configures the two or more groups of TCI states

In some embodiments, a DCI format of the received DCI indicates whether the one or more TCI states to be activated at the WCD are one or more DL TCI states or one or more UL TCI states.

In some embodiments, a DCI format of the received DCI indicates whether the one or more TCI states to be activated at the WCD are one or more DL TCI states, one or more UL TCI states, or both DL and UL TCI states.

In some embodiments, an RNTI of the received DCI indicates whether the one or more TCI states to be activated at the WCD are one or more DL TCI states or one or more UL TCI states.

In some embodiments, an RNTI of the received DCI indicates whether the one or more TCI states to be activated at the WCD are one or more DL TCI states, one or more UL TCI states, or both DL and UL TCI states.

In some embodiments, the one or more TCI states to be activated at the WCD comprises two or more DL TCI states for a single codepoint of a TCI field of DCI, two or more UL TCI states for a single codepoint of the TCI field, or both two or more DL TCI states and two or more UL TCI states for a single codepoint of the TCI field.

In some embodiments, the WCD maintains separate lists of activated DL and/or UL TCI states for two or more TRPs or two or more CORESET pools.

In some embodiments, the WCD maintains separate lists of activated DL and/or UL TCI states for two or more SSBs and/or PCIs.

Corresponding embodiments of a network node are also disclosed. In one embodiment, a network node is adapted to send, to a WCD, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD.

In another embodiment, a network node comprises one or more transmitters, one or more receivers, and processing circuitry. The processing circuitry is configured to cause the network node to send, to a WCD, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates New Radio (NR) time-domain structure with 15 kHz subcarrier spacing;

FIG. 2 illustrates a basic NR physical time-frequency resource grid, where only one Resource Block (RB) within a 14-symbol slot is shown;

FIG. 3 illustrates the Transmission/Configuration Indicator (TCI) state information element as defined in Third Generation Partnership Project (3GPP) Technical Specification (TS) 38.331, NR; Radio Resource Control (RRC); Protocol Specification, V16.2.0 (10-2020);

FIG. 4 depicts a two-step procedure related to TCI state update;

FIG. 5 illustrates the structure of the Medium Access Control (MAC) Control Element (CE) for activating/deactivating TCI states for User Equipment (UE)-specific Physical Downlink Shared Channel (PDSCH) as defined in 3GPP TS 38.321, MAC protocol specification, V.16.2.0 (10-2020);

FIG. 6 illustrates an example of a Downlink Control Information (DCI) indication of a TCI state;

FIG. 7 illustrates one example of a cellular communications system in which embodiments of the present disclosure may be implemented;

FIG. 8 is a schematic that illustrates a joint list of activated downlink (DL) TCI states and uplink (UL) TCI states where both the activated DL TCI states and activated UL TCI states are associated to the same list of DCI codepoints according to some embodiments of the present disclosure;

FIG. 9 is a schematic that illustrates two separate lists of activated TCI states, each with its own association to a codepoint for DL TCI states and a codepoint for UL TCI states according to some embodiments of the present disclosure;

FIG. 10 illustrates an example schematic in which the TCI state index indicated in DCI is used to update only DL TCI state of a codepoint according to some embodiments of the present disclosure;

FIG. 11 illustrates an example schematic in which the TCI state index indicated in DCI is used to update only the UL TCI state of a codepoint according to some embodiments of the present disclosure;

FIG. 12 illustrates an example schematic in which the TCI state index indicated in DCI is used to update both the DL TCI state and the UL TCI state of a codepoint according to some embodiments of the present disclosure;

FIG. 13 illustrates an example schematic in which the codepoint which the TCI state activation should be applied to is explicitly signaled in the DCI according to some embodiments of the present disclosure;

FIG. 14 illustrates an example schematic in which the DCI contains two bitfields for TCI state activation according to some embodiments of the present disclosure;

FIG. 15 illustrates an example schematic in which the DCI contains two bitfields for TCI state activation and an additional bitfield that explicitly indicate for which codepoint the TCI state activation should apply to, according to some embodiments of the present disclosure;

FIG. 16 illustrates an example schematic in which the DCI contains two bitfields for TCI state activation and two additional bitfields that explicitly indicate for which codepoint the TCI state activation should apply to for respective DL TCI state and UL TCI state according to some embodiments of the present disclosure;

FIG. 17 shows an example of indicating DL and/or UL TCI state groups via DCI according to some embodiments of the present disclosure;

FIG. 18 illustrates the operation of a network node and a Wireless Communication Device (WCD) in accordance with at least some of the described embodiments;

FIG. 19 is a schematic block diagram of the network node according to some embodiments of the present disclosure;

FIG. 20 is a schematic block diagram that illustrates a virtualized embodiment of the network node according to some embodiments of the present disclosure;

FIG. 21 is a schematic block diagram of the network node according to some other embodiments of the present disclosure;

FIG. 22 is a schematic block diagram of a WCD according to some embodiments of the present disclosure;

FIG. 23 is a schematic block diagram of the WCD according to some other embodiments of the present disclosure;

FIG. 24 illustrates a communication system includes a telecommunication network, such as a 3GPP-type cellular network, according to some embodiments of the present disclosure;

FIG. 25 illustrates example implementations of the previously described UE, base station, and host computer according to some embodiments of the present disclosure;

FIG. 26 is a flowchart illustrating a method implemented in a communication system, in accordance with one embodiment;

FIG. 27 is a flowchart illustrating a method implemented in a communication system, in accordance with one embodiment;

FIG. 28 is a flowchart illustrating a method implemented in a communication system, in accordance with one embodiment;

FIG. 29 is a flowchart illustrating a method implemented in a communication system, in accordance with one embodiment; and

FIG. 30 illustrates enhanced TCI states activation/deactivation for UE-specific PDSCH MAC CE as defined in FIG. 6.1.3.24-1 of 3GPP TS 38.321 V16.0.0 (04-2020).

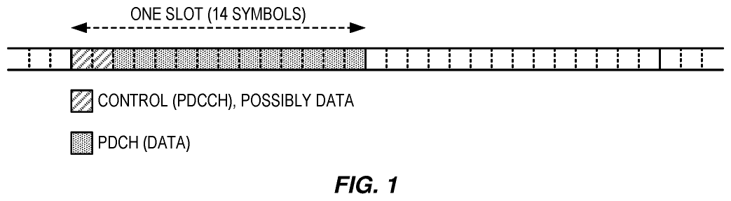

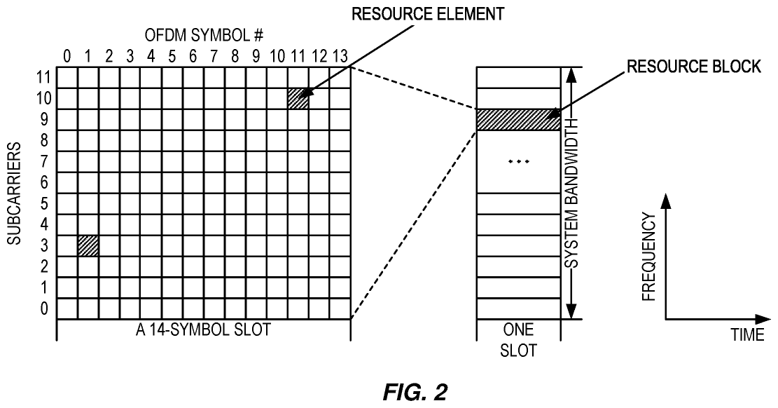

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

In 3GPP Rel-17, a new enhanced TCI state framework will be specified. Specifically, in 3GPP Technical Specification Group (TSG) RAN WG1 e-meeting RAN1 #103-e, it was agreed that the new TCI state framework should include a three stage TCI state indication (in a similar way as was described above for PDSCH) for all or a subset of all DL and/or UL channels/signals. In the first stage, RRC is used to configure a pool of TCI states. In the second stage, one or more of the RRC configured TCI states are activated via MAC-CE signaling. Finally, in the third stage, DCI signaling is used to select one of the TCI states that was activated via MAC-CE. The TCI states used for DL channels/signals and UL channels/signals, can either be taken from the same pool of TCI states or from separate respective pools of TCI states. It is also possible that two separate lists of activated TCI states are used, one for DL channels/signals and one for UL channels/signals.

Some agreements from the RAN1 #103-e meeting is copied below:

### Begin Excerpt from RAN1 #103-e Meeting

### Agreement

On beam indication signaling medium to support joint or separate DL/UL beam indication in Rel.17 unified TCI framework:
Support L1-based beam indication using at least UE-specific (unicast) DCI to indicate joint or separate DL/UL beam indication from the active TCI states
   The existing DCI formats 1_1 and 1_2 are reused for beam indication
Support activation of one or more TCI states via MAC CE analogous to Rel.15/16:

### Agreement

On Rel-17 unified TCI framework, to accommodate the case of separate beam indication for UL and DL:
Utilize two separate TCI states, one for DL and one for UL.
For the separate DL TCI:
   The source reference signal(s) in M TCIs provide QCL information at least for UE-dedicated reception on PDSCH and for UE-dedicated reception on all or subset of CORESETs in a CC
For the separate UL TCI:
   The source reference signal(s) in N TCIs provide a reference for determining common UL TX spatial filter(s) at least for dynamic-grant/configured-grant based PUSCH, all or subset of dedicated PUCCH resources in a CC
   Optionally, this UL TX spatial filter can also apply to all SRS resources in resource set(s) configured for antenna switching/codebook-based/non-codebook-based UL transmissions
FFS: Whether the UL TCI state is taken from a common/same or separate TCI state pool from DL TCI state

### End Excerpt from RAN1 #103-e Meeting

There currently exist certain challenge(s). Frequently updating the list of activated TCI states with MAC-CE will increase the latency and overhead for high mobility UEs. In the Prior Application, a method describing how to update the list of activated TCI states using DCI was disclosed. However, the method in the Prior Application does not describe how to update the activated TCI when having two separate lists of activated TCI states, i.e., one with DL TCI states and one with UL TCI states. Hence, how to use DCI to update the list(s) of activated DL and UL TCI states is still an open issue that needs to be solved.

Certain aspects of the present disclosure and their embodiments may provide solutions to the aforementioned or other challenges. Systems and methods are disclosed herein that provide a signaling framework for updating the list of activated TCI states using DCI, where the activated TCI states can be DL TCI states and/or UL TCI states. Certain embodiments may provide one or more of the following technical advantage(s). Embodiments of the present disclosure may speed up and simplify TCI state selection for DL channels/signals and/or UL channels/signals, since MAC CE based signaling can be avoided.

There are, proposed herein, various embodiments which address one or more of the issues disclosed herein. Embodiments of a method performed by a wireless communication device (WCD) are disclosed. In one embodiment, the method includes receiving, from a network node, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD. The method further comprises updating a list of activated DL TCI states at the WCD, a list of activated UL TCI states at the WCD, or both the list of activated DL TCI states and the list of activated UL TCI states at the WCD, based on the received DCI.

In one embodiment, for each TCI state of the one or more TCI states to be activated at the WCD 712, the DCI further includes information that indicates whether the TCI state is an DL TCI state or an UL TCI state. In another embodiment, for each TCI state of the one or more TCI states to be activated at the WCD 712, the DCI further includes information that indicates whether the TCI state is an DL TCI state, an UL TCI state, or both a DL TCI state and an UL TCI state.

In one embodiment, the one or more TCI states to be activated at the WCD 712 are to be mapped to (i.e., applied to) a particular one of a plurality of codepoints of a TCI field in a DCI, and the DCI further comprises information that indicates the particular one of the plurality of codepoints. In another embodiment, for each TCI state of the one or more TCI states to be activated at the WCD 712, the DCI further comprises information that indicates one of a plurality of codepoints of a TCI field in a DCI to which the TCI state is to be mapped (i.e., to be applied).

In one embodiment, the one or more TCI states to be activated at the WCD 712 comprises a DL TCI state and an UL TCI state, and the DCI includes a first field for indication of a DL TCI state that comprises a TCI index of the DL TCI state to be activated at the WCD 712 and a second field for indication of an UL TCI state that comprises a TCI index of the DL TCI state to be activated at the WCD 712. In one embodiment, the DCI further includes a third field that comprises information that indicates one of plurality of codepoints of a TCI field of a DCI to which the DL TCI state and the UL TCI state are to be applied (i.e., to be mapped). In one embodiment, the DCI further includes a third field that comprises information that indicates a first one of plurality of codepoints of a TCI field of a DCI to which the DL TCI state is to be applied (i.e., to be mapped) and a fourth field that comprises information that indicates a second one of plurality of codepoints of the TCI field to which the UL TCI state is to be applied (i.e., to be mapped).

In one embodiment, the one or more TCI states to be activated at the WCD 712 are one of two or more groups of TCI states, and the information comprised in the DCI that indicates the one or more TCI states is information (e.g., a group index) that indicates the one of the two or more groups of TCI states. In one embodiment, the two or more groups of TCI states are configured by the network (e.g., by the WCD 712 receiving information that configures the two or more groups of TCI states, e.g., from the network node 1800).

In one embodiment, a DCI format of the received DCI indicates whether the one or more TCI states to be activated at the WCD 712 are one or more DL TCI states or one or more UL TCI states. In another embodiment, a DCI format of the received DCI indicates whether the one or more TCI states to be activated at the WCD 712 are one or more DL TCI states, one or more UL TCI states, or both DL and UL TCI states. In another embodiment, an RNTI of the received DCI indicates whether the one or more TCI states to be activated at the WCD 712 are one or more DL TCI states or one or more UL TCI states. In another embodiment, an RNTI of the received DCI indicates whether the one or more TCI states to be activated at the WCD 712 are one or more DL TCI states, one or more UL TCI states, or both DL and UL TCI states.

In one embodiment, the one or more TCI states to be activated at the WCD 712 comprises two or more DL TCI states for a single codepoint of a TCI field of DCI, two or more UL TCI states for a single codepoint of the TCI field, or both two or more DL TCI states and two or more UL TCI states for a single codepoint of the TCI field. In another embodiment, the WCD 712 maintains separate lists of activated DL and/or UL TCI states for two or more TRPs or two or more CORESET pools. In another embodiment, the WCD 712 maintains separate lists of activated DL and/or UL TCI states for two or more SSBs and/or PCIs.

The WCD 712 updates a list of activated DL TCI states at the WCD 712, a list of activated UL TCI states at the WCD 712, or both the list of activated DL TCI states and the list of activated UL TCI states at the WCD 712 based on the received DCI (step 18006). In other words, the WCD 712 replaces the previously activated UL and/or DL TCI states for particular codepoint(s) of the TCI field with the UL and/or DL TCI states indicated by the DCI of step 18004.

The WCD 712 may also receive a DCI that includes the TCI field set to a particular codepoint (step 18008) and uses the UL and/or DL TCI state(s) mapped to that codepoint for UL transmission and/or DL reception (step 18010). Note that the indication of the activated UL and/or DL TCI state(s) to use may, rather than being received in a separate DCI of 18008, be included in the DCI of step 18004.

Corresponding embodiments of a WCD are also disclosed. In one embodiment, a WCD is adapted to receive, from a network node, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD. The WCD is further adapted to update a list of activated DL TCI states at the WCD, a list of activated UL TCI states at the WCD, or both the list of activated DL TCI states and the list of activated UL TCI states at the WCD, based on the received DCI.

Embodiments of a method performed by a network node are also disclosed. In one embodiment, the method comprises sending, to a WCD, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD.

Corresponding embodiments of a network node are also disclosed. In one embodiment, a network node is adapted to send, to a WCD, DCI that comprises information indicates one or more TCI states to be activated at the WCD. The one or more TCI states to be activated at the WCD comprise one or more DL TCI states to be activated at the WCD, one or more UL TCI states to be activated at the WCD, or both one or more DL TCI states to be activated at the WCD and one or more UL TCI states to be activated at the WCD.

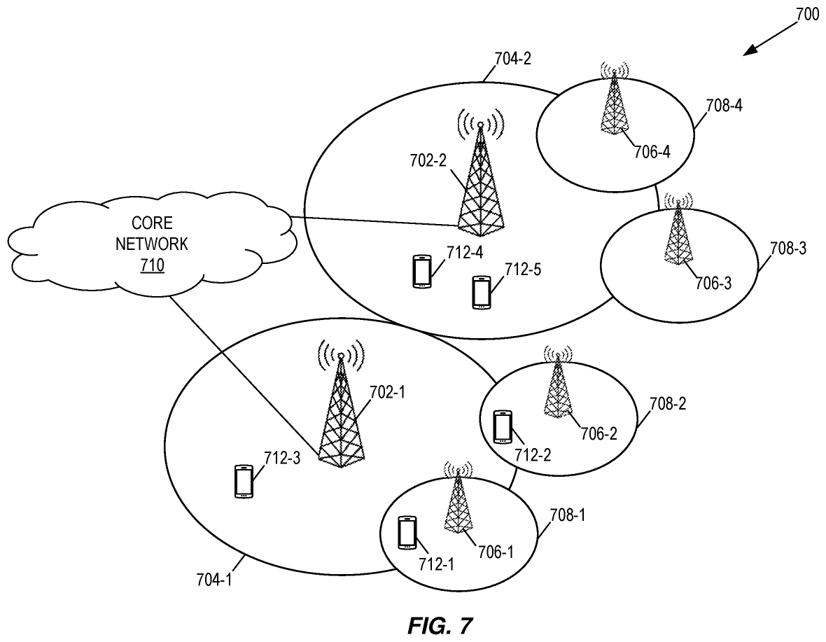

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC), however the embodiments disclosed herein are not limited thereto. In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices (WCDs) 712-1 through 712-5 in the corresponding cells 704 and 708. The WCDs 712-1 through 712-5 are generally referred to herein collectively as WCDs 712 and individually as WCD 712. In the following description, the WCDs 712 are oftentimes UEs, but the present disclosure is not limited thereto.

Now, embodiments of a signaling framework for updating the list of activated TCI states using DCI, where the activated TCI states can be DL TCI states and/or UL TCI states, will be described.

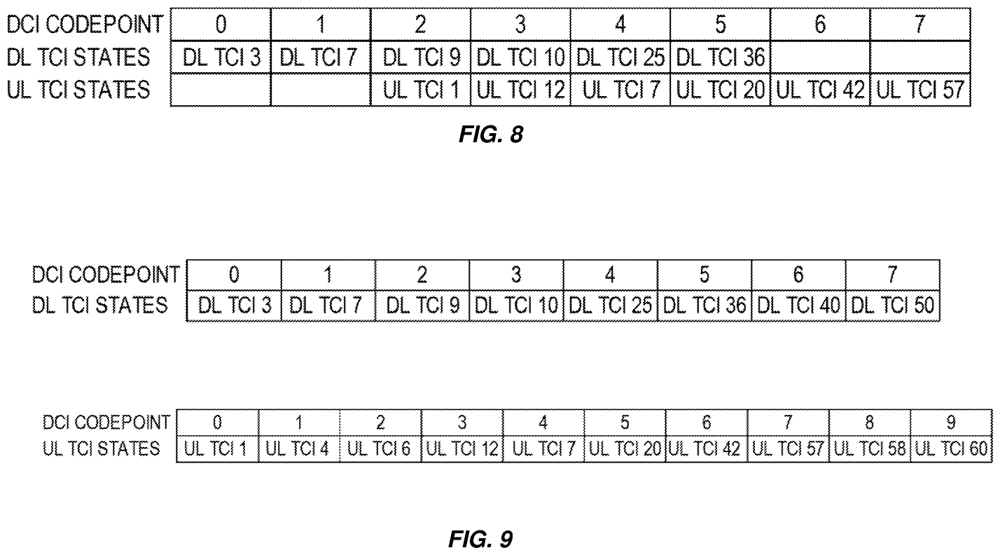

There are two possible implementations when using DCI to select one activated DL TCI state and/or one activated UL TCI states. In one option, there is a joint list of activated DL TCI states and UL TCI states where both the activated DL TCI states and activated UL TCI states are associated to the same list of DCI codepoints. An example is provided in FIG. 8. FIG. 8 is a schematic that illustrates a joint list of activated DL TCI states and UL TCI states where both the activated DL TCI states and activated UL TCI states are associated to the same list of DCI codepoints. In this case, a single codepoint in DCI can be used to update either a DL TCI state (e.g., codepoints 0 and 1 in the example of FIG. 8), or an UL TCI state (e.g., codepoints 6 and 7 in the example of FIG. 8), or both a DL and an UL TCI state (e.g., codepoints 2, 3, 4 and 5 in the example of FIG. 8). For example, in case an indicated DCI contains the codepoint 2 (e.g., in the TCI field of the DCI) of FIG. 8, the WCD 712 (e.g., UE) should apply DL TCI state 9 for DL signals/channels and UL TCI state 1 for UL signals/channels.

Returning to FIG. 7, in the second option, two separate lists of activated TCI states are used, and each list has its own association to a codepoint, one for DL TCI states and one for UL TCI states. An example is provided in FIG. 9. FIG. 9 is a schematic that illustrates two separate lists of activated TCI states, each with its own association to a codepoint for DL TCI states and a codepoint for UL TCI states . . . \ In this case, different TCI state bit fields in the same DCI or different TCI state bit fields in different DCIs could be used to update the DL TCI states and UL TCI state respectively.

The embodiments of the present disclosure are described with reference to the first option described in FIG. 8 (i.e., where a single list of codepoints are associated to DL and/or UL TCI states). However, most of the embodiments are also applicable for the second option described in FIG. 9 (i.e., for the case where separate lists of activate TCI states are used for DL and UL TCI states and each list is associated with its own codepoint).

Returning to FIG. 7, in one embodiment of the present disclosure, the list of activated DL and UL TCI states is updated using DCI. The DCI includes one or more new DL TCI state indexes to activate and/or one or more new UL TCI states to activate. Upon receiving the DCI, the WCD 712 (e.g., UE) replaces some of the currently activated DL TCI states and/or UL TCI states by the signaled DL TCI state indexes and/or UL TCI state indexes.

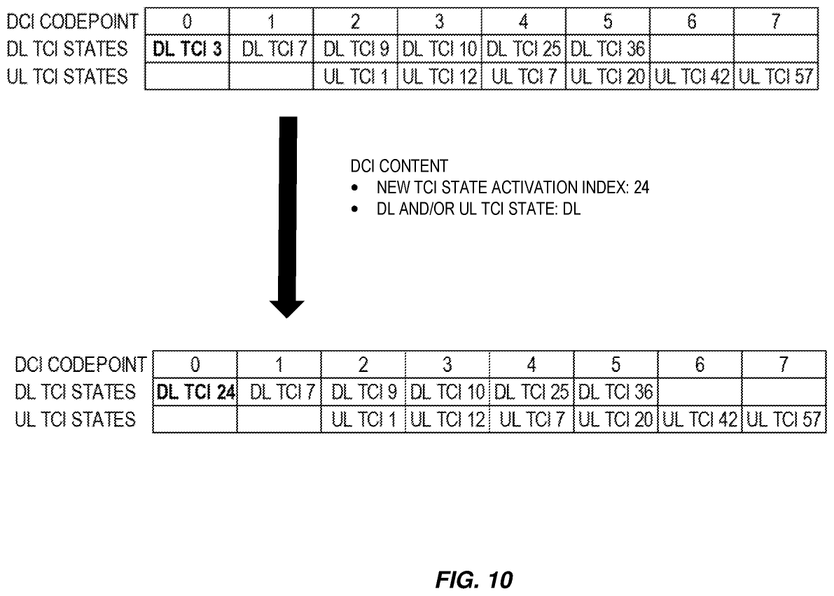

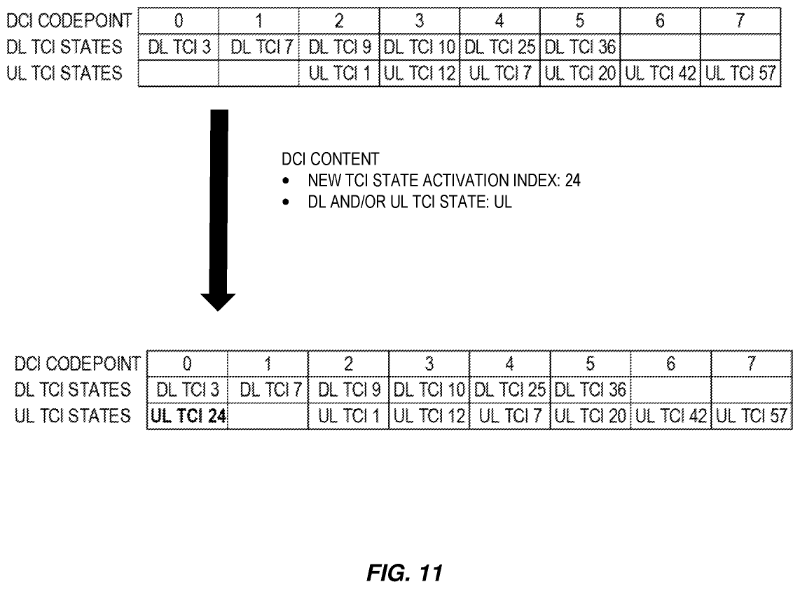

In one embodiment, for each signaled TCI state index to be activated, an additional bitfield indicates if the TCI state index is an DL TCI state index or an UL TCI state index, as schematically illustrated in the examples of FIG. 10 and FIG. 11. FIG. 10 illustrates an example schematic in which the TCI state index indicated in DCI is used to update only DL TCI state of a codepoint. FIG. 11 illustrates an example schematic in which the TCI state index indicated in DCI is used to update only the UL TCI state of a codepoint. Even though the TCI state index updated is mapped to codepoint 0 in these examples, however, in an alternate variant of this embodiment, the last codepoint in the list (codepoint 7 in this case) or another dedicated codepoint can be updated. If a dedicated codepoint is to be updated, this dedicated codepoint can be specified as part of 3GPP specifications.

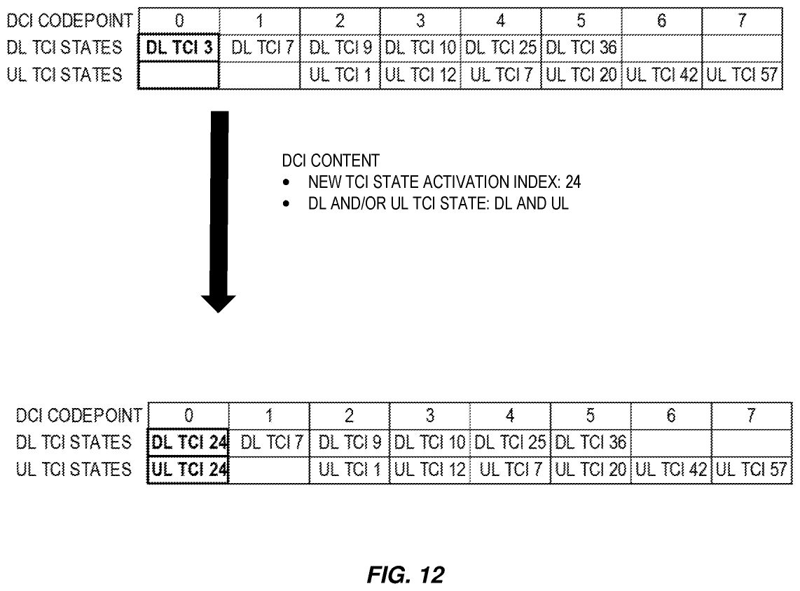

In one embodiment, the TCI state index indicated in DCI is used to update both the DL TCI state and the UL TCI state of a codepoint, as schematically illustrated in the example of FIG. 12. In this example, an additional bitfield in DCI indicates that the TCI state index is to be updated for both DL and UL.

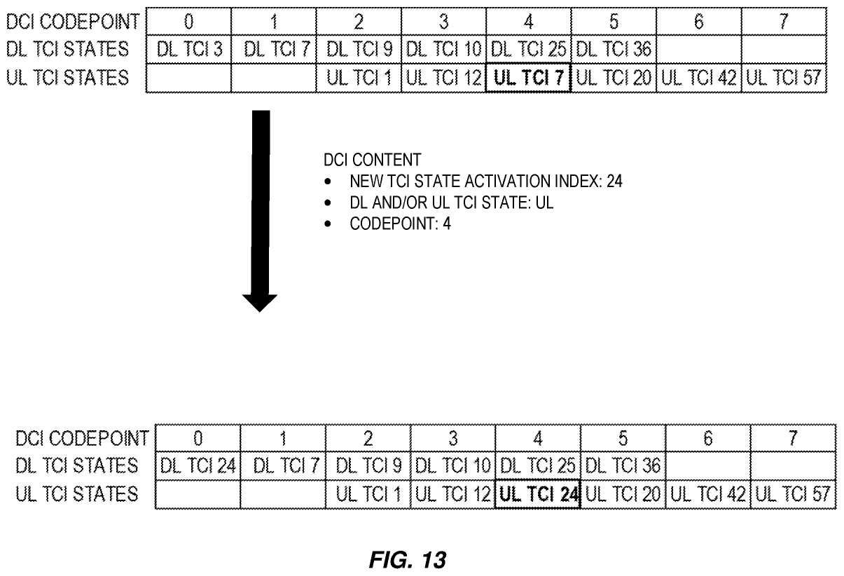

In one embodiment, the codepoint which the TCI state activation should be applied to is explicitly signaled in the DCI, as schematically illustrated in FIG. 13.

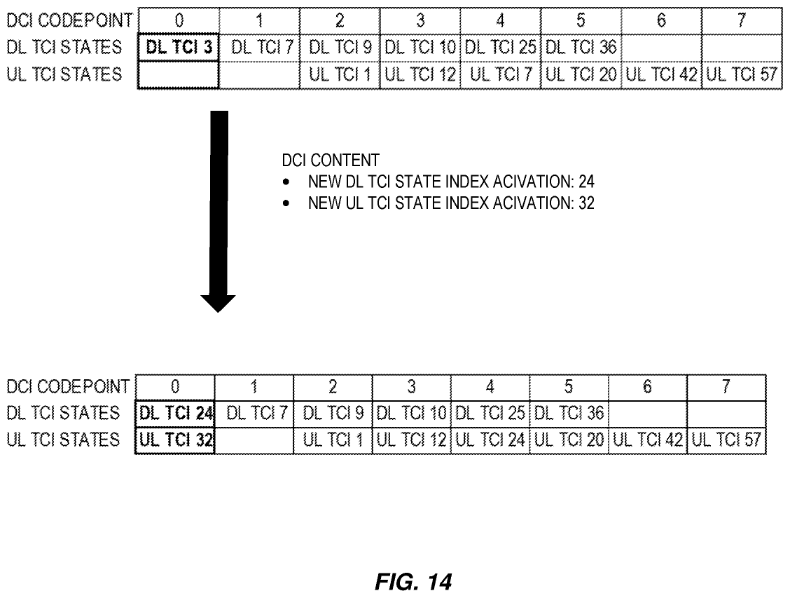

In one embodiment, the DCI contains two bitfields for TCI state activation, one that contains the DL TCI state index to be activated and one that contains the UL TCI state index to be activated, as schematically illustrated in FIG. 14. The bitfield to be update in this case is codepoint 0; however, in an alternate embodiment of this embodiment, the last of the activated codepoints (codepoint 7 in this case) or another dedicated codepoint can be updated.

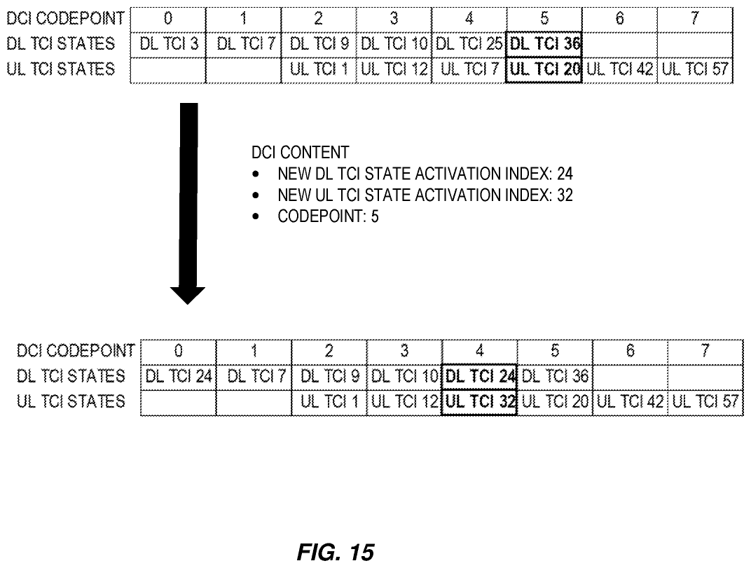

In one embodiment, the DCI contains two bitfields for TCI state activation (one for DL TCI state and one for UL TCI states as described above) and an additional bitfield that explicitly indicate for which codepoint the TCI state activation should apply to, as schematically illustrated in FIG. 15.

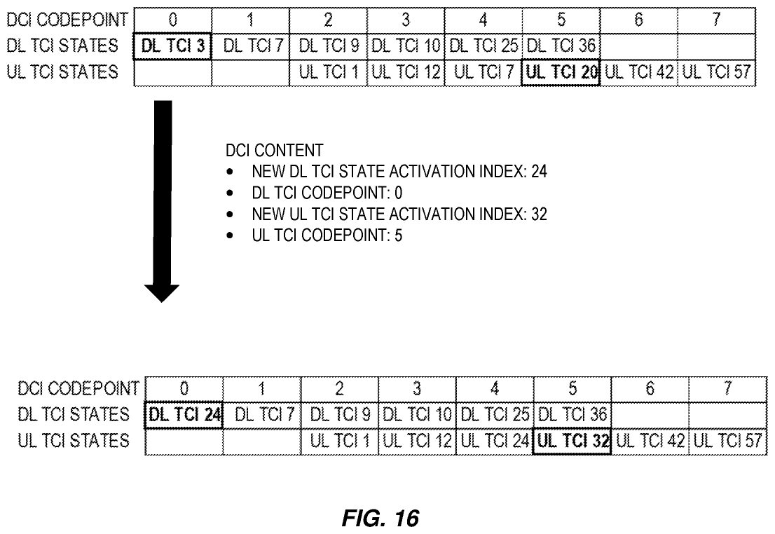

In one embodiment, the DCI contains two bitfields for TCI state activation (one for DL TCI state and one for UL TCI states as described above) and two additional bitfields that explicitly indicate for which codepoint the TCI state activation should apply to for respective DL TCI state and UL TCI state, as schematically illustrated in FIG. 16.

In another set of embodiments, the DCI is used to activate a group of DL and/or UL TCI states. In one embodiment, an indicator in DCI points to a predefined group of DL and/or UL TCI states. When such a DCI indication is received by the WCD 712 (e.g., UE), all the DL and/or UL TCI states in the indicated group of DL and/or UL TCI states are activated, and all the previously activated DL and/or UL TCI states are deactivated.

In one embodiment, the group of DL and/or UL TCI states may be configured, e.g., in higher layer signaling (e.g., RRC signaling). In one case, each TCI state may be configured with a DL and/or UL TCI state group index. The maximum number of groups may be configurable, defined in specifications, and/or be based on WCD capability. In another alternative case, the DL and/or UL TCI state groups may be configured as different lists, e.g., in higher layer signaling (e.g., RRC signaling). Each group may consist of a first list of DL TCI state indices and a second list of UL TCI state indices.

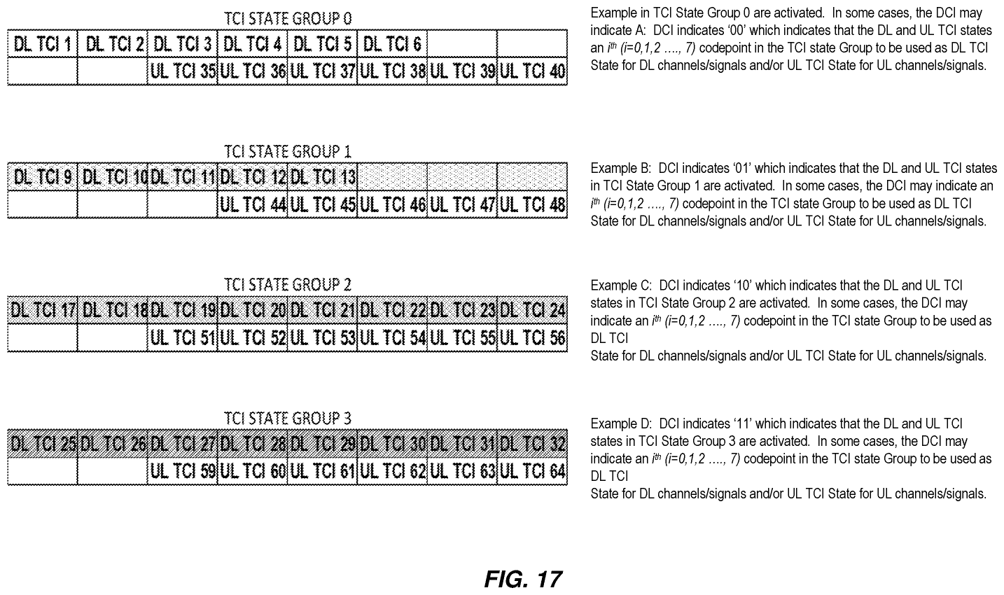

FIG. 17 shows an example of indicating DL and/or UL TCI state groups via DCI. In this embodiment, four DL and/or UL TCI state groups are preconfigured/predefined for the WCD 712 (e.g., UE) in a given BWP. Then, two bits are added in the activating DCI to indicate the DL and/or UL TCI state group. As shown in FIG. 17, when the activating DCI indicated DL and/or UL TCI state group 0 (by indicating bits ‘00’), the DL and/or UL TCI states in DL and/or UL TCI state group 0 are activated and the previously activated DL and/or UL TCI states are deactivated. In some embodiments, the activating DCI may also indicate one of the DL and/or UL TCI states (e.g., via an index) in the TCI state Group, and the indicated DL TCI state is used for DL channels/signals, and the indicated UL state is used for UL channels/signals.

Note that some of the above embodiments only contain a maximum of one activated DL TCI state and/or UL TCI state per DCI. However, these embodiments can easily be extended to include activation of multiple DL TCI states and/or multiple UL TCI states per DCI.

The DCI format used to update the list of activated TCI states can either be an old DCI format (e.g., DCI format 1_1 or 1_2) with new additional bitfield(s), or an old DCI format with a new RNTI or a new DCI format.

In one embodiment, it is pre-specified or configured (e.g., RRC configured) which DCI format(s) that are linked to activation of DL TCI states and UL TCI states. For example, DCI format 1_1 and 1_2 are always used to activate a DL TCI states, and DCI formats 0_1 and 0_2 are always used to activate an UL TCI states. In this way, there is no need for the extra bitfield indicating if the TCI state index refers to an activation of a DL TCI state/UL TCI state or both an DL TCI state and an UL TCI state (i.e., “DL and/or UL TCI state” in the above embodiments).

In one embodiment, different RNTIs of a specific DCI format is used to indicate if a TCI state activation should be applied for DL and/or UL TCI states. For example, a DCI format using RNTI_0 is used to activate a DL TCI state and the same DCI format using RNTI_1 is used to activate an UL TCI state.

Note that the DCI activating a DL and/or UL TCI state can also contain a bitfield selecting one of the activated DL and/or UL TCI states.

### Multi-TRP (m TRP) Related Embodiments

In another embodiment, there are more than one pairing of UL and DL TCI states in the serving cell configuration. Note that this pairing may refer to any of the above mentioned joint list (see FIG. 8), or separate lists of UL and/or DL TCI states (see FIG. 9). In these embodiments, we call this “pairing”. For example, there may be a pairing that is specific to a certain CORESETPoolindex (representing a TRP). This is for the case the UE is configured with multiple DCI mTRP operation. This pairing may be DL only, UL only, or to apply DL and UL simultaneously.

In another embodiment, if the UE is operating for single DCI based mTRP, one DCI can be used to update different TCI states for both TRPs. Here the options are as follows. There may be a pair of “pairings” which means that, in case of joint DL and UL TCI state list as presented in the very first embodiment above (see FIG. 8), there are two of these joint lists such that one list is applicable for TRP1 and the other list is applicable for TRP2. In this option, one DCI codepoint refers to four TCI states—or is defining the spatial direction for two DL and two UL directions used by the WCD 712 (e.g., UE). As another option, if the mTRP operation is applicable only in DL and UL is only towards one of the TRPs, there may be one joint list (see FIG. 8) (or another pairing) applicable for one of the TRPs and DL only TCI state applicable for the other TRP. In this option one DCI codepoint refers to three TCI states—or is defining the spatial direction for two DL and one UL directions used by the WCD 712.

In another embodiment, these TRPs may be associated with different SSB/PCI than the original or main SSB/PCI of the serving cell. This refers to the Release-17 intercell mTRP operation. Even if the WCD 712 is not configured with or does not operate with mTRP, the WCD 712 may have additional SSB/PCIs configured in its serving cell configuration. In either case, these SSB/PCI may have an index and the pairing of DL/UL TCI states may be associated to this index in a similar way as described for the CORESETPoolIndex.

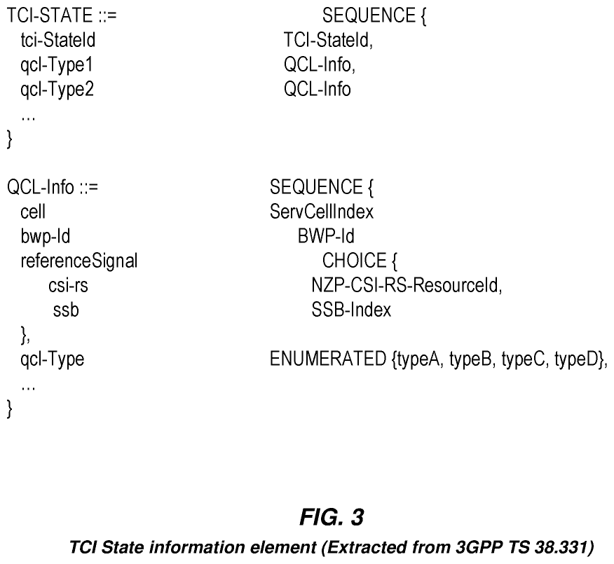

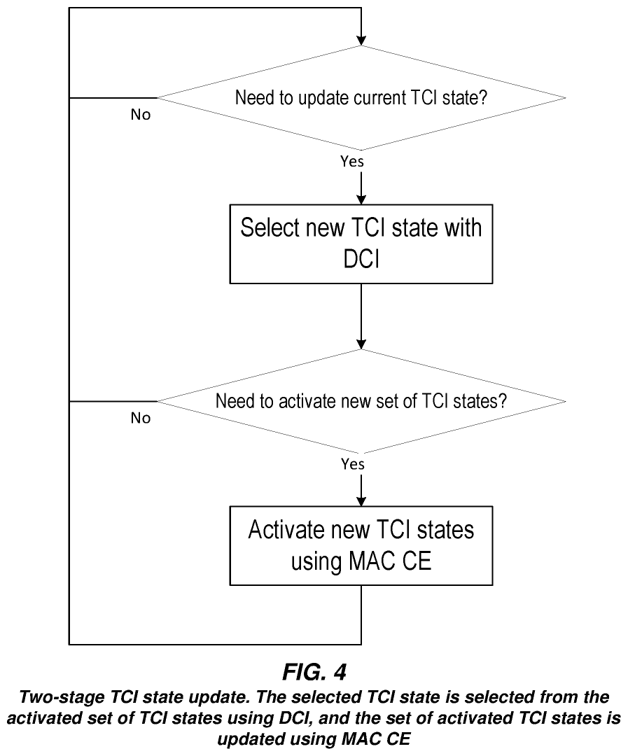

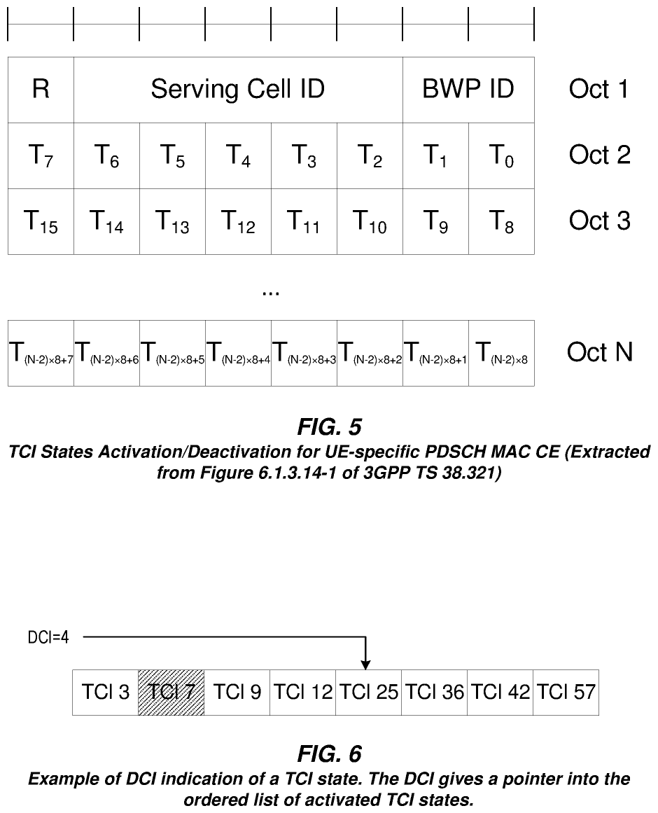

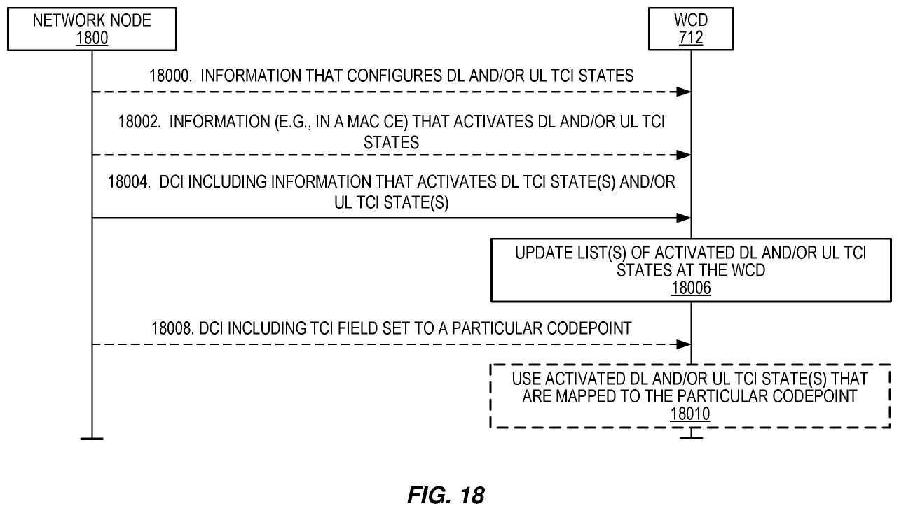

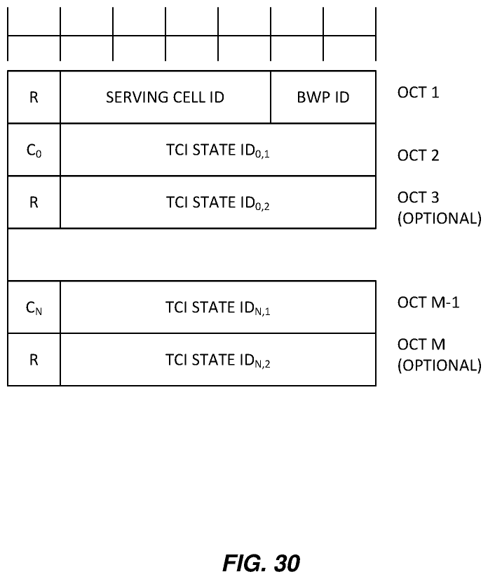

FIG. 18 illustrates the operation of a network node 1800 (e.g., a base station 702 or a network node that implements at least part of the functionality of the base station 702, e.g., a gNB-DU, gNB-CU, or the like) and a WCD 712 (e.g., a UE) in accordance with at least some of the embodiments described above. Optional steps are represented by dashed lines/boxes. As illustrated, the network node 1800 sends information to the WCD 712 that configures DL TCI states and UL TCI states for the WCD 712 (step 18000). This information may be sent via, e.g., RRC signaling (e.g., via TCI State information element of FIG. 3 or similar thereto). The network node 1800 may also activate one or more DL TCI states and/or one or more UL TCI states, e.g., via a MAC CE such as or similar to that in FIG. 6.1.3.24-1 of 3GPP TS 38.321 V16.0.0 (04-2020), which is reproduced herein as FIG. 30 (step 18002).

The network node 1800 sends, to the WCD 712, (and the WCD 712 receives) DCI that includes information that indicates one or more TCI states (e.g., one or more of the TCI states configured in step 18000) to be activated at the WCD 712 (step 18004). The one or more TCI states to be activated that are indicated in the DCI include one or more DL TCI states to be activated at the WCD 712, one or more UL TCI states to be activated at the WCD 712, or both one or more DL TCI states to be activated at the WCD 712 and one or more UL TCI states to be activated at the WCD 712.

The DCI of step 18004 is in accordance with any of the embodiments described above. As such, the details regarding embodiments of the DCI for indicating DL and/or UL TCI states to be activated provided above are equally applicable here. In one embodiment, for each TCI state of the one or more TCI states to be activated at the WCD 712, the DCI further includes information that indicates whether the TCI state is an DL TCI state or an UL TCI state. In another embodiment, for each TCI state of the one or more TCI states to be activated at the WCD 712, the DCI further includes information that indicates whether the TCI state is an DL TCI state, an UL TCI state, or both a DL TCI state and an UL TCI state.

In one embodiment, the one or more TCI states to be activated at the WCD 712 are to be mapped to (i.e., applied to) a particular one of a plurality of codepoints of a TCI field in a DCI, and the DCI further comprises information that indicates the particular one of the plurality of codepoints. In another embodiment, for each TCI state of the one or more TCI states to be activated at the WCD 712, the DCI further comprises information that indicates one of a plurality of codepoints of a TCI field in a DCI to which the TCI state is to be mapped (i.e., to be applied).

In one embodiment, the one or more TCI states to be activated at the WCD 712 comprises a DL TCI state and an UL TCI state, and the DCI includes a first field for indication of a DL TCI state that comprises a TCI index of the DL TCI state to be activated at the WCD 712 and a second field for indication of an UL TCI state that comprises a TCI index of the DL TCI state to be activated at the WCD 712. In one embodiment, the DCI further includes a third field that comprises information that indicates one of plurality of codepoints of a TCI field of a DCI to which the DL TCI state and the UL TCI state are to be applied (i.e., to be mapped). In one embodiment, the DCI further includes a third field that comprises information that indicates a first one of plurality of codepoints of a TCI field of a DCI to which the DL TCI state is to be applied (i.e., to be mapped) and a fourth field that comprises information that indicates a second one of plurality of codepoints of the TCI field to which the UL TCI state is to be applied (i.e., to be mapped).

In one embodiment, the one or more TCI states to be activated at the WCD 712 are one of two or more groups of TCI states, and the information comprised in the DCI that indicates the one or more TCI states is information (e.g., a group index) that indicates the one of the two or more groups of TCI states. In one embodiment, the two or more groups of TCI states are configured by the network (e.g., by the WCD 712 receiving information that configures the two or more groups of TCI states, e.g., from the network node 1800).

In one embodiment, a DCI format of the received DCI indicates whether the one or more TCI states to be activated at the WCD 712 are one or more DL TCI states or one or more UL TCI states. In another embodiment, a DCI format of the received DCI indicates whether the one or more TCI states to be activated at the WCD 712 are one or more DL TCI states, one or more UL TCI states, or both DL and UL TCI states. In another embodiment, an RNTI of the received DCI indicates whether the one or more TCI states to be activated at the WCD 712 are one or more DL TCI states or one or more UL TCI states. In another embodiment, an RNTI of the received DCI indicates whether the one or more TCI states to be activated at the WCD 712 are one or more DL TCI states, one or more UL TCI states, or both DL and UL TCI states.

In one embodiment, the one or more TCI states to be activated at the WCD 712 comprises two or more DL TCI states for a single codepoint of a TCI field of DCI, two or more UL TCI states for a single codepoint of the TCI field, or both two or more DL TCI states and two or more UL TCI states for a single codepoint of the TCI field. In another embodiment, the WCD 712 maintains separate lists of activated DL and/or UL TCI states for two or more TRPs or two or more CORESET pools. In another embodiment, the WCD 712 maintains separate lists of activated DL and/or UL TCI states for two or more SSBs and/or PCIs.

The WCD 712 updates a list of activated DL TCI states at the WCD 712, a list of activated UL TCI states at the WCD 712, or both the list of activated DL TCI states and the list of activated UL TCI states at the WCD 712 based on the received DCI (step 18006). In other words, the WCD 712 replaces the previously activated UL and/or DL TCI states for particular codepoint(s) of the TCI field with the UL and/or DL TCI states indicated by the DCI of step 18004.

The WCD 712 may also receive a DCI that includes the TCI field set to a particular codepoint (step 18008) and uses the UL and/or DL TCI state(s) mapped to that codepoint for UL transmission and/or DL reception (step 18010). Note that the indication of the activated UL and/or DL TCI state(s) to use may, rather than being received in a separate DCI of 18008, be included in the DCI of step 18004.

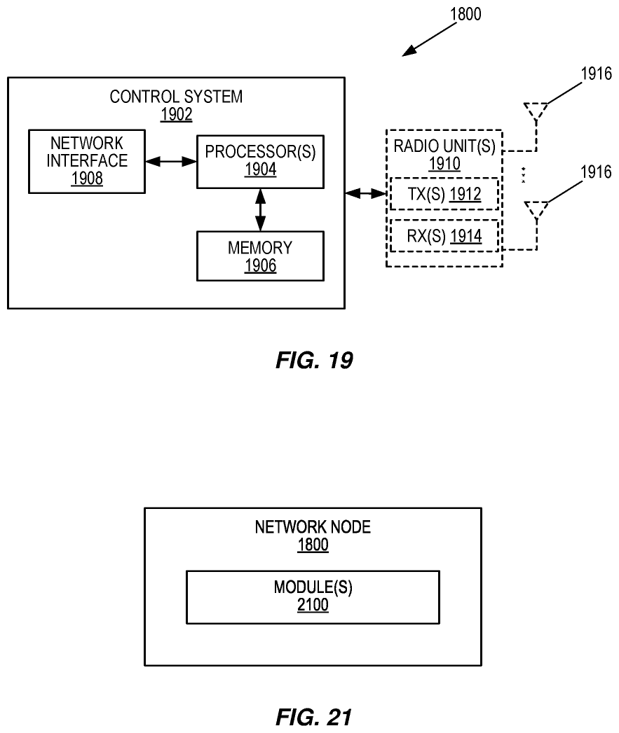

FIG. 19 is a schematic block diagram of the network node 1800 according to some embodiments of the present disclosure. Optional features are represented by dashed boxes. The network node 1800 may be, for example, a base station 702 or 706 or a network node that implements all or part of the functionality of the base station 702 or gNB described herein. As illustrated, the network node 1800 includes a control system 1902 that includes one or more processors 1904 (e.g., Central Processing Units (CPUs), Application Specific Integrated Circuits (ASICs), Field Programmable Gate Arrays (FPGAs), and/or the like), memory 1906, and a network interface 1908. The one or more processors 1904 are also referred to herein as processing circuitry. In addition, the network node 1800 may include one or more radio units 1910 that each includes one or more transmitters 1912 and one or more receivers 1914 coupled to one or more antennas 1916. The radio units 1910 may be referred to or be part of radio interface circuitry. In some embodiments, the radio unit(s) 1910 is external to the control system 1902 and connected to the control system 1902 via, e.g., a wired connection (e.g., an optical cable). However, in some other embodiments, the radio unit(s) 1910 and potentially the antenna(s) 1916 are integrated together with the control system 1902. The one or more processors 1904 operate to provide one or more functions of the network node 1800 as described herein. In some embodiments, the function(s) are implemented in software that is stored, e.g., in the memory 1906 and executed by the one or more processors 1904.

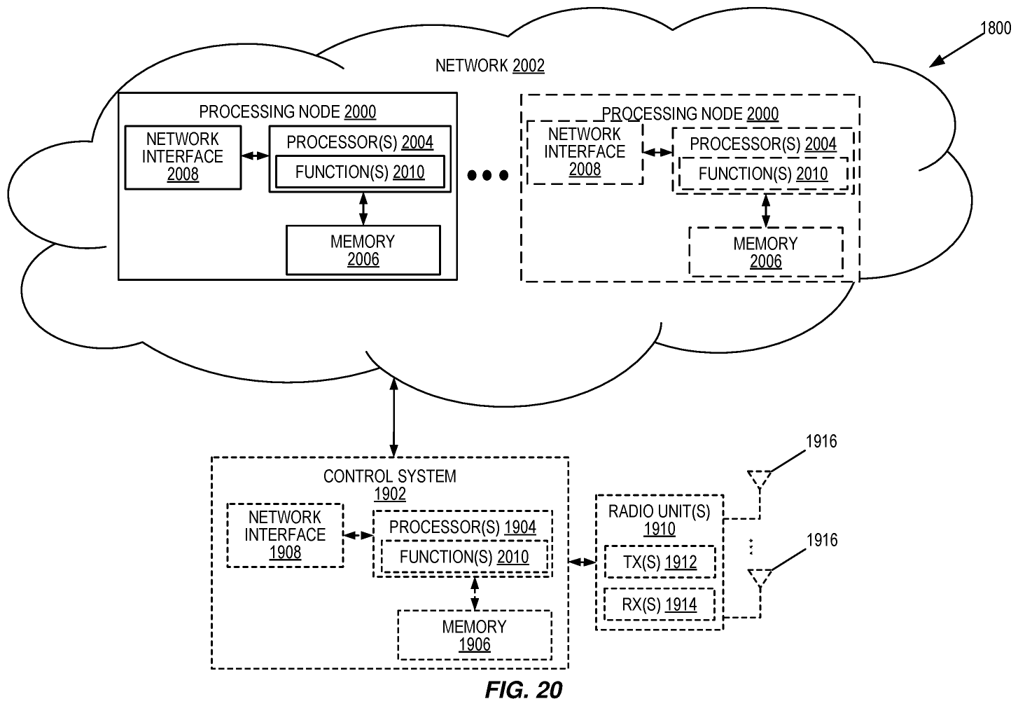

FIG. 20 is a schematic block diagram that illustrates a virtualized embodiment of the network node 1800 according to some embodiments of the present disclosure. Again, optional features are represented by dashed boxes. As used herein, a “virtualized” network node is an implementation of the network node 1800 in which at least a portion of the functionality of the network node 1800 is implemented as a virtual component(s) (e.g., via a virtual machine(s) executing on a physical processing node(s) in a network(s)). As illustrated, in this example, the network node 1800 may include the control system 1902 and/or the one or more radio units 1910, as described above. The control system 1902 may be connected to the radio unit(s) 1910 via, for example, an optical cable or the like. The network node 1800 includes one or more processing nodes 2000 coupled to or included as part of a network(s) 2002. If present, the control system 1902 or the radio unit(s) are connected to the processing node(s) 2000 via the network 2002. Each processing node 2000 includes one or more processors 2004 (e.g., CPUs, ASICs, FPGAs, and/or the like), memory 2006, and a network interface 2008.

In this example, functions 2010 of the network node 1800 described herein are implemented at the one or more processing nodes 2000 or distributed across the one or more processing nodes 2000 and the control system 1902 and/or the radio unit(s) 1910 in any desired manner. In some particular embodiments, some or all of the functions 2010 of the network node 1800 described herein are implemented as virtual components executed by one or more virtual machines implemented in a virtual environment(s) hosted by the processing node(s) 2000. As will be appreciated by one of ordinary skill in the art, additional signaling or communication between the processing node(s) 2000 and the control system 1902 is used in order to carry out at least some of the desired functions 2010. Notably, in some embodiments, the control system 1902 may not be included, in which case the radio unit(s) 1910 communicate directly with the processing node(s) 2000 via an appropriate network interface(s).

In some embodiments, a computer program including instructions which, when executed by at least one processor, causes the at least one processor to carry out the functionality of the network node 1800 or a node (e.g., a processing node 2000) implementing one or more of the functions 2010 of the network node 1800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 21 is a schematic block diagram of the network node 1800 according to some other embodiments of the present disclosure. The network node 1800 includes one or more modules 2100, each of which is implemented in software. The module(s) 2100 provide the functionality of the network node 1800 described herein. This discussion is equally applicable to the processing node 2000 of FIG. 20 where the modules 2100 may be implemented at one of the processing nodes 2000 or distributed across multiple processing nodes 2000 and/or distributed across the processing node(s) 2000 and the control system 1902.

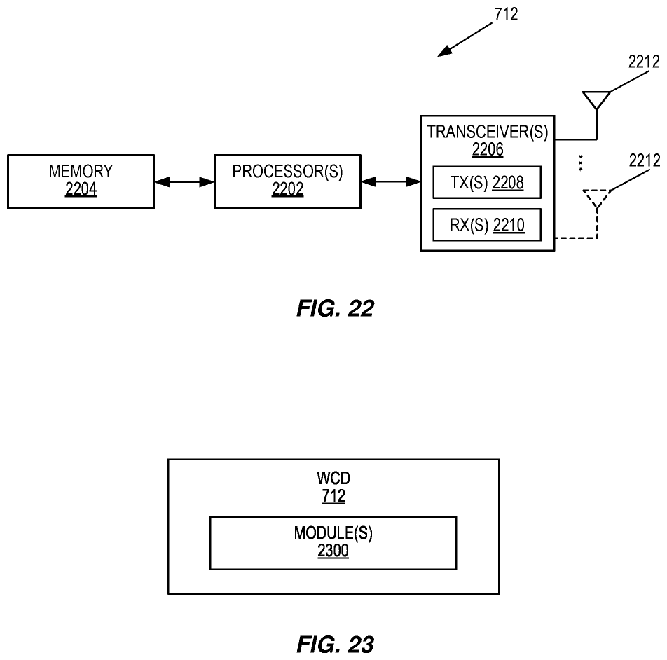

FIG. 22 is a schematic block diagram of the WCD 712 according to some embodiments of the present disclosure. As illustrated, the WCD 712 includes one or more processors 2202 (e.g., CPUs, ASICs, FPGAs, and/or the like), memory 2204, and one or more transceivers 2206 each including one or more transmitters 2208 and one or more receivers 2210 coupled to one or more antennas 2212. The transceiver(s) 2206 includes radio-front end circuitry connected to the antenna(s) 2212 that is configured to condition signals communicated between the antenna(s) 2212 and the processor(s) 2202, as will be appreciated by on of ordinary skill in the art. The processors 2202 are also referred to herein as processing circuitry. The transceivers 2206 are also referred to herein as radio circuitry. In some embodiments, the functionality of the WCD 712 described above may be fully or partially implemented in software that is, e.g., stored in the memory 2204 and executed by the processor(s) 2202. Note that the WCD 712 may include additional components not illustrated in FIG. 22 such as, e.g., one or more user interface components (e.g., an input/output interface including a display, buttons, a touch screen, a microphone, a speaker(s), and/or the like and/or any other components for allowing input of information into the WCD 712 and/or allowing output of information from the WCD 712), a power supply (e.g., a battery and associated power circuitry), etc.

In some embodiments, a computer program including instructions which, when executed by at least one processor, causes the at least one processor to carry out the functionality of the WCD 712 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 23 is a schematic block diagram of the WCD 712 according to some other embodiments of the present disclosure. The WCD 712 includes one or more modules 2300, each of which is implemented in software. The module(s) 2300 provide the functionality of the WCD 712 described herein.

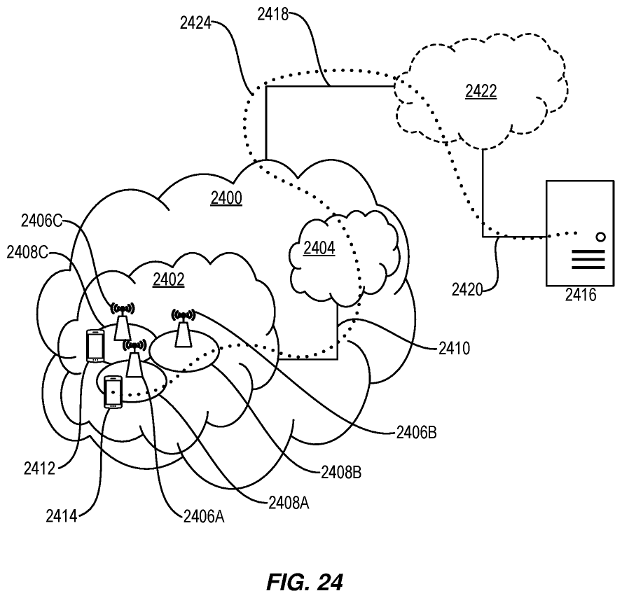

With reference to FIG. 24, in accordance with an embodiment, a communication system includes a telecommunication network 2400, such as a 3GPP-type cellular network, which comprises an access network 2402, such as a RAN, and a core network 2404. The access network 2402 comprises a plurality of base stations 2406A, 2406B, 2406C, such as Node Bs, eNBs, gNBs, or other types of wireless Access Points (APs), each defining a corresponding coverage area 2408A, 2408B, 2408C. Each base station 2406A, 2406B, 2406C is connectable to the core network 2404 over a wired or wireless connection 2410. A first UE 2412 located in coverage area 2408C is configured to wirelessly connect to, or be paged by, the corresponding base station 2406C. A second UE 2414 in coverage area 2408A is wirelessly connectable to the corresponding base station 2406A. While a plurality of UEs 2412, 2414 are illustrated in this example, the disclosed embodiments are equally applicable to a situation where a sole UE is in the coverage area or where a sole UE is connecting to the corresponding base station 2406.

The telecommunication network 2400 is itself connected to a host computer 2416, which may be embodied in the hardware and/or software of a standalone server, a cloud-implemented server, a distributed server, or as processing resources in a server farm. The host computer 2416 may be under the ownership or control of a service provider, or may be operated by the service provider or on behalf of the service provider. Connections 2418 and 2420 between the telecommunication network 2400 and the host computer 2416 may extend directly from the core network 2404 to the host computer 2416 or may go via an optional intermediate network 2422. The intermediate network 2422 may be one of, or a combination of more than one of, a public, private, or hosted network; the intermediate network 2422, if any, may be a backbone network or the Internet; in particular, the intermediate network 2422 may comprise two or more sub-networks (not shown).

The communication system of FIG. 24 as a whole enables connectivity between the connected UEs 2412, 2414 and the host computer 2416. The connectivity may be described as an Over-the-Top (OTT) connection 2424. The host computer 2416 and the connected UEs 2412, 2414 are configured to communicate data and/or signaling via the OTT connection 2424, using the access network 2402, the core network 2404, any intermediate network 2422, and possible further infrastructure (not shown) as intermediaries. The OTT connection 2424 may be transparent in the sense that the participating communication devices through which the OTT connection 2424 passes are unaware of routing of uplink and downlink communications. For example, the base station 2406 may not or need not be informed about the past routing of an incoming downlink communication with data originating from the host computer 2416 to be forwarded (e.g., handed over) to a connected UE 2412. Similarly, the base station 2406 need not be aware of the future routing of an outgoing uplink communication originating from the UE 2412 towards the host computer 2416.

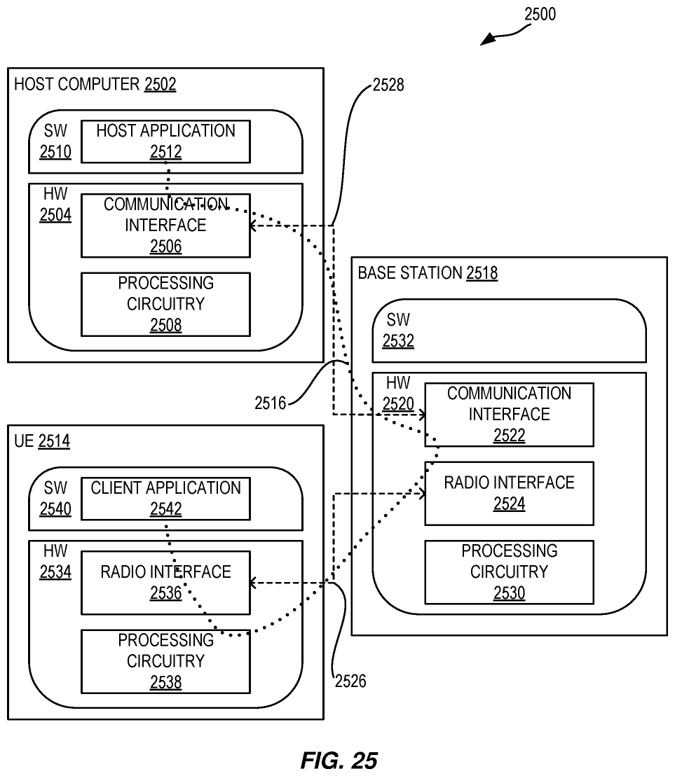

Example implementations, in accordance with an embodiment, of the UE, base station, and host computer discussed in the preceding paragraphs will now be described with reference to FIG. 25. In a communication system 2500, a host computer 2502 comprises hardware 2504 including a communication interface 2506 configured to set up and maintain a wired or wireless connection with an interface of a different communication device of the communication system 2500. The host computer 2502 further comprises processing circuitry 2508, which may have storage and/or processing capabilities. In particular, the processing circuitry 2508 may comprise one or more programmable processors, ASICs, FPGAs, or combinations of these (not shown) adapted to execute instructions. The host computer 2502 further comprises software 2510, which is stored in or accessible by the host computer 2502 and executable by the processing circuitry 2508. The software 2510 includes a host application 2512. The host application 2512 may be operable to provide a service to a remote user, such as a UE 2514 connecting via an OTT connection 2516 terminating at the UE 2514 and the host computer 2502. In providing the service to the remote user, the host application 2512 may provide user data which is transmitted using the OTT connection 2516.

The communication system 2500 further includes a base station 2518 provided in a telecommunication system and comprising hardware 2520 enabling it to communicate with the host computer 2502 and with the UE 2514. The hardware 2520 may include a communication interface 2522 for setting up and maintaining a wired or wireless connection with an interface of a different communication device of the communication system 2500, as well as a radio interface 2524 for setting up and maintaining at least a wireless connection 2526 with the UE 2514 located in a coverage area (not shown in FIG. 25) served by the base station 2518. The communication interface 2522 may be configured to facilitate a connection 2528 to the host computer 2502. The connection 2528 may be direct or it may pass through a core network (not shown in FIG. 25) of the telecommunication system and/or through one or more intermediate networks outside the telecommunication system. In the embodiment shown, the hardware 2520 of the base station 2518 further includes processing circuitry 2530, which may comprise one or more programmable processors, ASICs, FPGAs, or combinations of these (not shown) adapted to execute instructions. The base station 2518 further has software 2532 stored internally or accessible via an external connection.

The communication system 2500 further includes the UE 2514 already referred to. The UE's 2514 hardware 2534 may include a radio interface 2536 configured to set up and maintain a wireless connection 2526 with a base station serving a coverage area in which the UE 2514 is currently located. The hardware 2534 of the UE 2514 further includes processing circuitry 2538, which may comprise one or more programmable processors, ASICs, FPGAs, or combinations of these (not shown) adapted to execute instructions. The UE 2514 further comprises software 2540, which is stored in or accessible by the UE 2514 and executable by the processing circuitry 2538. The software 2540 includes a client application 2542. The client application 2542 may be operable to provide a service to a human or non-human user via the UE 2514, with the support of the host computer 2502. In the host computer 2502, the executing host application 2512 may communicate with the executing client application 2542 via the OTT connection 2516 terminating at the UE 2514 and the host computer 2502. In providing the service to the user, the client application 2542 may receive request data from the host application 2512 and provide user data in response to the request data. The OTT connection 2516 may transfer both the request data and the user data. The client application 2542 may interact with the user to generate the user data that it provides.

It is noted that the host computer 2502, the base station 2518, and the UE 2514 illustrated in FIG. 25 may be similar or identical to the host computer 2416, one of the base stations 2406A, 2406B, 2406C, and one of the UEs 2412, 2414 of FIG. 24, respectively. This is to say, the inner workings of these entities may be as shown in FIG. 25 and independently, the surrounding network topology may be that of FIG. 24.

In FIG. 25, the OTT connection 2516 has been drawn abstractly to illustrate the communication between the host computer 2502 and the UE 2514 via the base station 2518 without explicit reference to any intermediary devices and the precise routing of messages via these devices. The network infrastructure may determine the routing, which may be configured to hide from the UE 2514 or from the service provider operating the host computer 2502, or both. While the OTT connection 2516 is active, the network infrastructure may further take decisions by which it dynamically changes the routing (e.g., on the basis of load balancing consideration or reconfiguration of the network).

The wireless connection 2526 between the UE 2514 and the base station 2518 is in accordance with the teachings of the embodiments described throughout this disclosure. One or more of the various embodiments improve the performance of OTT services provided to the UE 2514 using the OTT connection 2516, in which the wireless connection 2526 forms the last segment.

A measurement procedure may be provided for the purpose of monitoring data rate, latency, and other factors on which the one or more embodiments improve. There may further be an optional network functionality for reconfiguring the OTT connection 2516 between the host computer 2502 and the UE 2514, in response to variations in the measurement results. The measurement procedure and/or the network functionality for reconfiguring the OTT connection 2516 may be implemented in the software 2510 and the hardware 2504 of the host computer 2502 or in the software 2540 and the hardware 2534 of the UE 2514, or both. In some embodiments, sensors (not shown) may be deployed in or in association with communication devices through which the OTT connection 2516 passes; the sensors may participate in the measurement procedure by supplying values of the monitored quantities exemplified above, or supplying values of other physical quantities from which the software 2510, 2540 may compute or estimate the monitored quantities. The reconfiguring of the OTT connection 2516 may include message format, retransmission settings, preferred routing, etc.; the reconfiguring need not affect the base station 2518, and it may be unknown or imperceptible to the base station 2518. Such procedures and functionalities may be known and practiced in the art. In certain embodiments, measurements may involve proprietary UE signaling facilitating the host computer 2502's measurements of throughput, propagation times, latency, and the like. The measurements may be implemented in that the software 2510 and 2540 causes messages to be transmitted, in particular empty or ‘dummy’ messages, using the OTT connection 2516 while it monitors propagation times, errors, etc.

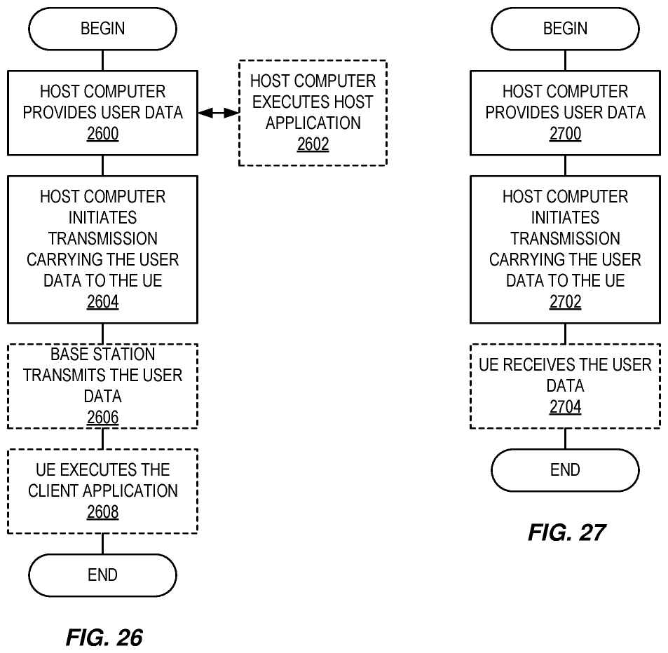

FIG. 26 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 26 will be included in this section. In step 2600, the host computer provides user data. In sub-step 2602 (which may be optional) of step 2600, the host computer provides the user data by executing a host application. In step 2604, the host computer initiates a transmission carrying the user data to the UE. In step 2606 (which may be optional), the base station transmits to the UE the user data which was carried in the transmission that the host computer initiated, in accordance with the teachings of the embodiments described throughout this disclosure. In step 2608 (which may also be optional), the UE executes a client application associated with the host application executed by the host computer.

FIG. 27 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 27 will be included in this section. In step 2700 of the method, the host computer provides user data. In an optional sub-step (not shown) the host computer provides the user data by executing a host application. In step 2702, the host computer initiates a transmission carrying the user data to the UE. The transmission may pass via the base station, in accordance with the teachings of the embodiments described throughout this disclosure. In step 2704 (which may be optional), the UE receives the user data carried in the transmission.

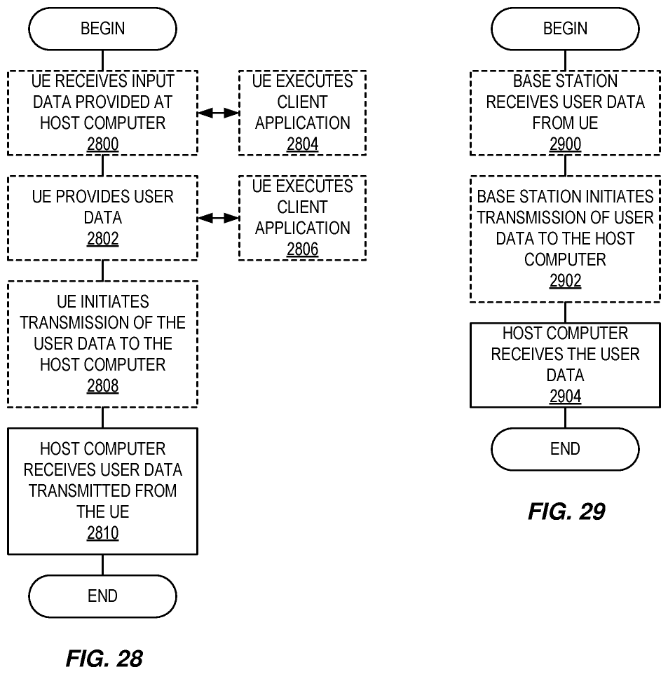

FIG. 28 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 28 will be included in this section. In step 2800 (which may be optional), the UE receives input data provided by the host computer. Additionally or alternatively, in step 2802, the UE provides user data. In sub-step 2804 (which may be optional) of step 2800, the UE provides the user data by executing a client application. In sub-step 2806 (which may be optional) of step 2802, the UE executes a client application which provides the user data in reaction to the received input data provided by the host computer. In providing the user data, the executed client application may further consider user input received from the user. Regardless of the specific manner in which the user data was provided, the UE initiates, in sub-step 2808 (which may be optional), transmission of the user data to the host computer. In step 2810 of the method, the host computer receives the user data transmitted from the UE, in accordance with the teachings of the embodiments described throughout this disclosure.

FIG. 29 is a flowchart illustrating a method implemented in a communication system, in accordance with one embodiment. The communication system includes a host computer, a base station, and a UE which may be those described with reference to FIGS. 24 and 25. For simplicity of the present disclosure, only drawing references to FIG. 29 will be included in this section. In step 2900 (which may be optional), in accordance with the teachings of the embodiments described throughout this disclosure, the base station receives user data from the UE. In step 2902 (which may be optional), the base station initiates transmission of the received user data to the host computer. In step 2904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a wireless communication device, WCD, (712), the method comprising one or more of the following:
receiving (18004), from a network node (1800), downlink control information, DCI, that comprises information that indicates one or more Transmission Configuration Indicator, TCI, states to be activated at the WCD (712), wherein the one or more TCI states to be activated at the WCD (712) comprise:
   one or more downlink, DL, TCI states to be activated at the WCD (712);
   one or more uplink, UL, TCI states to be activated at the WCD (712); or
   both one or more DL TCI states to be activated at the WCD (712) and one or more UL TCI states to be activated at the WCD (712); and
updating (18006) a list of activated DL TCI states at the WCD (712), a list of activated UL TCI states at the WCD (712), or both the list of activated DL TCI states and the list of activated UL TCI states at the WCD (712) based on the received DCI.

Embodiment 2: The method of embodiment 1 wherein, for each TCI state of the one or more TCI states to be activated at the WCD (712), the DCI further comprises information that indicates whether the TCI state is an DL TCI state or an UL TCI state.

Embodiment 3: The method of embodiment 1 wherein, for each TCI state of the one or more TCI states to be activated at the WCD (712), the DCI further comprises information that indicates whether the TCI state is an DL TCI state, an UL TCI state, or both a DL TCI state and an UL TCI state.

Embodiment 4: The method of any of embodiments 1 to 3 wherein the one or more TCI states to be activated at the WCD (712) are to be mapped to (i.e., applied to) a particular one of a plurality of codepoints of a TCI field in a DCI, and the DCI further comprises information that indicates the particular one of the plurality of codepoints.

Embodiment 5: The method of any of embodiments 1 to 3 wherein, for each TCI state of the one or more TCI states to be activated at the WCD (712), the DCI further comprises information that indicates one of a plurality of codepoints of a TCI field in a DCI to which the TCI state is to be mapped (i.e., to be applied).

Embodiment 6: The method of embodiment 1 wherein:
the one or more TCI states to be activated at the WCD (712) comprises a DL TCI state and an UL TCI state; and
the DCI comprises:
   a first field for indication of a DL TCI state that comprises a TCI index of the DL TCI state to be activated at the WCD (712); and
   a second field for indication of an UL TCI state that comprises a TCI index of the UL TCI state to be activated at the WCD (712).

Embodiment 7: The method of embodiment 6 wherein the DCI further comprises a third field that comprises information that indicates one of plurality of codepoints of a TCI field of a DCI to which the DL TCI state and the UL TCI state are to be applied (i.e., to be mapped).

Embodiment 8: The method of embodiment 6 wherein the DCI further comprises:
a third field that comprises information that indicates a first one of plurality of codepoints of a TCI field of a DCI to which the DL TCI state is to be applied (i.e., to be mapped); and
a fourth field that comprises information that indicates a second one of plurality of codepoints of the TCI field to which the UL TCI state is to be applied (i.e., to be mapped).

Embodiment 9: The method of embodiment 1 wherein the one or more TCI states to be activated at the WCD (712) are one of two or more groups of TCI states, and the information comprised in the DCI that indicates the one or more TCI states is information (e.g., a group index) that indicates the one of the two or more groups of TCI states.

Embodiment 10: The method of embodiment 9 further comprising receiving, from a network node, information that configures the two or more groups of TCI states.

Embodiment 11: The method of any of embodiments 1, 9, and 10 wherein a DCI format of the received DCI indicates whether the one or more TCI states to be activated at the WCD (712) are one or more DL TCI states or one or more UL TCI states.

Embodiment 12: The method of any of embodiments 1, 9, and 10 wherein a DCI format of the received DCI indicates whether the one or more TCI states to be activated at the WCD (712) are one or more DL TCI states, one or more UL TCI states, or both DL and UL TCI states.

Embodiment 13: The method of any of embodiments 1, 9, and 10 wherein an RNTI of the received DCI indicates whether the one or more TCI states to be activated at the WCD (712) are one or more DL TCI states or one or more UL TCI states.

Embodiment 14: The method of any of embodiments 1, 9, and 10 wherein an RNTI of the received DCI indicates whether the one or more TCI states to be activated at the WCD (712) are one or more DL TCI states, one or more UL TCI states, or both DL and UL TCI states.

Embodiment 15: The method of any of embodiments 1 to 14 wherein the one or more TCI states to be activated at the WCD (712) comprises two or more DL TCI states for a single codepoint of a TCI field of DCI, two or more UL TCI states for a single codepoint of the TCI field, or both two or more DL TCI states and two or more UL TCI states for a single codepoint of the TCI field.

Embodiment 16: The method of any of embodiments 1 to 14 wherein the WCD (712) maintains separate lists of activated DL and/or UL TCI states for two or more TRPs or two or more CORESET pools.

Embodiment 17: The method of any of embodiments 1 to 14 wherein the WCD (712) maintains separate lists of activated DL and/or UL TCI states for two or more SSBs and/or PCIs.

Embodiment 18: The method of any of the previous embodiments, further comprising:
providing user data; and
forwarding the user data to a host computer via the transmission to the base station.

### Group B Embodiments

Embodiment 19: A method performed by a network node (1800) (e.g., a base station 702), the method comprising:
sending (18004), to a wireless communication device, WCD, (712), a downlink control information, DCI, that comprises information indicates one or more Transmission Configuration Indicator, TCI, states to be activated at the WCD (712), wherein the one or more TCI states to be activated at the WCD (712) comprise:
   one or more downlink, DL, TCI states to be activated at the WCD (712);
   one or more uplink, UL, TCI states to be activated at the WCD (712); or
   both one or more DL TCI states to be activated at the WCD (712) and one or more UL TCI states to be activated at the WCD (712).

Embodiment 20: The method of embodiment 19 wherein, for each TCI state of the one or more TCI states to be activated at the WCD (712), the DCI further comprises information that indicates whether the TCI state is an DL TCI state or an UL TCI state.

Embodiment 21: The method of embodiment 19 wherein, for each TCI state of the one or more TCI states to be activated at the WCD (712), the DCI further comprises information that indicates whether the TCI state is an DL TCI state, an UL TCI state, or both a DL TCI state and an UL TCI state.

Embodiment 22: The method of any of embodiments 19 to 21 wherein the one or more TCI states to be activated at the WCD (712) are to be mapped to (i.e., applied to) a particular one of a plurality of codepoints of a TCI field in a DCI, and the DCI further comprises information that indicates the particular one of the plurality of codepoints.

Embodiment 23: The method of any of embodiments 19 to 21 wherein, for each TCI state of the one or more TCI states to be activated at the WCD (712), the DCI further comprises information that indicates one of a plurality of codepoints of a TCI field in a DCI to which the TCI state is to be mapped (i.e., to be applied).

Embodiment 24: The method of embodiment 19 wherein:
the one or more TCI states to be activated at the WCD (712) comprises a DL TCI state and an UL TCI state; and
the DCI comprises:
   a first field for indication of a DL TCI state that comprises a TCI index of the DL TCI state to be activated at the WCD (712); and
   a second field for indication of an UL TCI state that comprises a TCI index of the UL TCI state to be activated at the WCD (712).
   The method of embodiment 24 wherein the DCI further comprises a third field that comprises information that indicates one of plurality of codepoints of a TCI field of a DCI to which the DL TCI state and the UL TCI state are to be applied (i.e., to be mapped).

Embodiment 25: The method of embodiment 24 wherein the DCI further comprises:
a third field that comprises information that indicates a first one of plurality of codepoints of a TCI field of a DCI to which the DL TCI state is to be applied (i.e., to be mapped); and
a fourth field that comprises information that indicates a second one of plurality of codepoints of the TCI field to which the UL TCI state is to be applied (i.e., to be mapped).

Embodiment 26: The method of embodiment 19 wherein the one or more TCI states to be activated at the WCD (712) is one of two or more groups of TCI states, and the information comprised in the DCI that indicates the one or more TCI states is information (e.g., a group index) that indicates the one of the two or more groups of TCI states.

Embodiment 27: The method of embodiment 27 further comprising receiving, from a network node, information that configures the two or more groups of TCI states.

Embodiment 28: The method of any of embodiments 19, 27, and 28 wherein a DCI format of the received DCI indicates whether the one or more TCI states to be activated at the WCD (712) are one or more DL TCI states or one or more UL TCI states.

Embodiment 29: The method of any of embodiments 19, 27, and 28 wherein a DCI format of the received DCI indicates whether the one or more TCI states to be activated at the WCD (712) are one or more DL TCI states, one or more UL TCI states, or both DL and UL TCI states.

Embodiment 30: The method of any of embodiments 1, 27, and 28 wherein an RNTI of the received DCI indicates whether the one or more TCI states to be activated at the WCD (712) are one or more DL TCI states or one or more UL TCI states.

Embodiment 31: The method of any of embodiments 19, 27, and 28 wherein an RNTI of the received DCI indicates whether the one or more TCI states to be activated at the WCD (712) are one or more DL TCI states, one or more UL TCI states, or both DL and UL TCI states.

Embodiment 32: The method of any of embodiments 19 to 32 wherein the one or more TCI states to be activated at the WCD (712) comprises two or more DL TCI states for a single codepoint of a TCI field of DCI, two or more UL TCI states for a single codepoint of the TCI field, or both two or more DL TCI states and two or more UL TCI states for a single codepoint of the TCI field.

Embodiment 33: The method of any of embodiments 19 to 32 wherein the WCD (712) maintains separate lists of activated DL and/or UL TCI states for two or more TRPs or two or more CORESET pools.

Embodiment 34: The method of any of embodiments 19 to 32 wherein the WCD (712) maintains separate lists of activated DL and/or UL TCI states for two or more SSBs and/or PCIs.

Embodiment 35: The method of any of the previous embodiments, further comprising:
obtaining user data; and
forwarding the user data to a host computer or a WCD.

### Group C Embodiments

Embodiment 36: A wireless communication device comprising:
processing circuitry configured to perform any of the steps of any of the Group A embodiments; and
power supply circuitry configured to supply power to the wireless communication device.

Embodiment 37: A network node comprising:
processing circuitry configured to perform any of the steps of any of the Group B embodiments; and
power supply circuitry configured to supply power to the network node.

Embodiment 38: A User Equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 39: A communication system including a host computer comprising:
processing circuitry configured to provide user data; and
a communication interface configured to forward the user data to a cellular network for transmission to a User Equipment, UE;
wherein the cellular network comprises a network node having a radio interface and processing circuitry, the network node's processing circuitry configured to perform any of the steps of any of the Group B embodiments.

Embodiment 40: The communication system of the previous embodiment further including the network node.

Embodiment 41: The communication system of the previous 2 embodiments, further including the UE, wherein the UE is configured to communicate with the network node.

Embodiment 42: The communication system of the previous 3 embodiments, wherein:
the processing circuitry of the host computer is configured to execute a host application, thereby providing the user data; and
the UE comprises processing circuitry configured to execute a client application associated with the host application.

Embodiment 43: A method implemented in a communication system including a host computer, a network node, and a User Equipment, UE, the method comprising:
at the host computer, providing user data; and
at the host computer, initiating a transmission carrying the user data to the UE via a cellular network comprising the network node, wherein the network node performs any of the steps of any of the Group B embodiments.

Embodiment 44: The method of the previous embodiment, further comprising, at the network node, transmitting the user data.

Embodiment 45: The method of the previous 2 embodiments, wherein the user data is provided at the host computer by executing a host application, the method further comprising, at the UE, executing a client application associated with the host application.

Embodiment 46: A User Equipment, UE, configured to communicate with a network node, the UE comprising a radio interface and processing circuitry configured to perform the method of the previous 3 embodiments.

Embodiment 47: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the Group A embodiments.

Embodiment 48: The communication system of the previous embodiment, wherein the cellular network further includes a network node configured to communicate with the UE.

Embodiment 49: The communication system of the previous 2 embodiments, wherein:
the processing circuitry of the host computer is configured to execute a host application, thereby providing the user data; and
the UE's processing circuitry is configured to execute a client application associated with the host application.

Embodiment 50: A method implemented in a communication system including a host computer, a network node, and a User Equipment, UE, the method comprising:
at the host computer, providing user data; and
at the host computer, initiating a transmission carrying the user data to the UE via a cellular network comprising the network node, wherein the UE performs any of the steps of any of the Group A embodiments.

Embodiment 51: The method of the previous embodiment, further comprising at the UE, receiving the user data from the network node.

Embodiment 52: A communication system including a host computer comprising:
communication interface configured to receive user data originating from a transmission from a User Equipment, UE, to a network node;
wherein the UE comprises a radio interface and processing circuitry, the UE's processing circuitry configured to perform any of the steps of any of the Group A embodiments.

Embodiment 53: The communication system of the previous embodiment, further including the UE.

Embodiment 54: The communication system of the previous 2 embodiments, further including the network node, wherein the network node comprises a radio interface configured to communicate with the UE and a communication interface configured to forward to the host computer the user data carried by a transmission from the UE to the network node.

Embodiment 55: The communication system of the previous 3 embodiments, wherein:
the processing circuitry of the host computer is configured to execute a host application; and
the UE's processing circuitry is configured to execute a client application associated with the host application, thereby providing the user data.

Embodiment 56: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 57: A method implemented in a communication system including a host computer, a network node, and a User Equipment, UE, the method comprising:
at the host computer, receiving user data transmitted to the network node from the UE, wherein the UE performs any of the steps of any of the Group A embodiments.

Embodiment 58: The method of the previous embodiment, further comprising, at the UE, providing the user data to the network node.

Embodiment 59: The method of the previous 2 embodiments, further comprising:
at the UE, executing a client application, thereby providing the user data to be transmitted; and
at the host computer, executing a host application associated with the client application.

Embodiment 60: The method of the previous 3 embodiments, further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 61: A communication system including a host computer comprising a communication interface configured to receive user data originating from a transmission from a User Equipment, UE, to a network node, wherein the network node comprises a radio interface and processing circuitry, the network node's processing circuitry configured to perform any of the steps of any of the Group B embodiments.

Embodiment 62: The communication system of the previous embodiment further including the network node.

Embodiment 63: The communication system of the previous 2 embodiments, further including the UE, wherein the UE is configured to communicate with the network node.

Embodiment 64: The communication system of the previous 3 embodiments, wherein:
the processing circuitry of the host computer is configured to execute a host application; and
the UE is configured to execute a client application associated with the host application, thereby providing the user data to be received by the host computer.

Embodiment 65: A method implemented in a communication system including a host computer, a network node, and a User Equipment, UE, the method comprising:
at the host computer, receiving, from the network node, user data originating from a transmission which the network node has received from the UE, wherein the UE performs any of the steps of any of the Group A embodiments.

Embodiment 66: The method of the previous embodiment, further comprising at the network node, receiving the user data from the UE.

Embodiment 67: The method of the previous 2 embodiments, further comprising at the network node, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
BWP Bandwidth Part
CE Control Element
CPU Central Processing Unit
CRB Common Resource Block
CSI-RS Channel State Information Reference Signal
DCI Downlink Control Information
DL Downlink
DMRS Demodulation Reference Signal
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
OFDM Orthogonal Frequency Division Multiplexing
OTT Over-the-Top
PC Personal Computer
PCF Policy Control Function
PCI Physical Cell Identifier
PDCH Physical Data Channel
PDCCH Physical Downlink Control Channel
PDSCH Physical Downlink Shared Channel
P-GW Packet Data Network Gateway
PRB Physical Resource Block
PUSCH Physical Uplink Shared Channel
QCL Quasi Co-Located
QoS Quality of Service
RAM Random Access Memory
RAN Radio Access Network
RB Resource Block
RE Resource Element
ROM Read Only Memory
RNTI Radio Network Temporary Identifier
RRC Radio Resource Control
RRH Remote Radio Head
RS Reference Signal
RTT Round Trip Time
SCEF Service Capability Exposure Function
SINR Signal to Interference plus Noise Ratio
SMF Session Management Function
SSB Synchronization Signal Block
TCI Transmission Configuration Indicator
TRP Transmission and Reception Point
UDM Unified Data Management
UE User Equipment
UL Uplink
UPF User Plane Function
WCD Wireless Communication Device

Those skilled in the art will recognize improvements and modifications to the embodiments of the present disclosure. All such improvements and modifications are considered within the scope of the concepts disclosed herein.

1. A method performed by a wireless communication device, WCD, the method comprising:
receiving, from a network node, downlink control information, DCI, that comprises information that indicates one or more Transmission Configuration Indicator, TCI, states to be activated at the WCD, wherein the one or more TCI states to be activated at the WCD comprise:
one or more downlink, DL, TCI states to be activated at the WCD;
one or more uplink, UL, TCI states to be activated at the WCD; or
both one or more DL TCI states to be activated at the WCD and one or more UL TCI states to be activated at the WCD; and
updating a list of activated DL TCI states at the WCD, a list of activated UL TCI states at the WCD, or both the list of activated DL TCI states and the list of activated UL TCI states at the WCD based on the received DCI.

2. The method of claim 1 wherein, for each TCI state of the one or more TCI states to be activated at the WCD, the DCI further comprises information that indicates whether the TCI state is an DL TCI state or an UL TCI state.

3. The method of claim 1 wherein, for each TCI state of the one or more TCI states to be activated at the WCD, the DCI further comprises information that indicates whether the TCI state is an DL TCI state, an UL TCI state, or both a DL TCI state and an UL TCI state.

4. The method of claim 1 wherein the one or more TCI states to be activated at the WCD are to be mapped to a particular one of a plurality of codepoints of a TCI field in a DCI, and the DCI further comprises information that indicates the particular one of the plurality of codepoints.

5. The method of claim 1 wherein, for each TCI state of the one or more TCI states to be activated at the WCD, the DCI further comprises information that indicates one of a plurality of codepoints of a TCI field in a DCI to which the TCI state is to be mapped.

6. The method of claim 1 wherein:
the one or more TCI states to be activated at the WCD comprises a DL TCI state and an UL TCI state; and
the DCI comprises:
a first field for indication of a DL TCI state that comprises a TCI index of the DL TCI state to be activated at the WCD; and
a second field for indication of an UL TCI state that comprises a TCI index of the UL TCI state to be activated at the WCD.

7. The method of claim 6 wherein the DCI further comprises a third field that comprises information that indicates one of plurality of codepoints of a TCI field of a DCI to which the DL TCI state and the UL TCI state are to be mapped.

8. The method of claim 6 wherein the DCI further comprises:
a third field that comprises information that indicates a first one of plurality of codepoints of a TCI field of a DCI to which the DL TCI state is to be mapped; and
a fourth field that comprises information that indicates a second one of plurality of codepoints of the TCI field to which the UL TCI state is to be applied mapped.

9. The method of claim 1 wherein the one or more TCI states to be activated at the WCD are one of two or more groups of TCI states, and the information comprised in the DCI that indicates the one or more TCI states is information that indicates the one of the two or more groups of TCI states.

10. The method of claim 9 further comprising receiving, from a network node, information that configures the two or more groups of TCI states.

11. The method of claim 1 wherein a DCI format of the received DCI indicates whether the one or more TCI states to be activated at the WCD are one or more DL TCI states or one or more UL TCI states.

12. The method of claim 1 wherein a DCI format of the received DCI indicates whether the one or more TCI states to be activated at the WCD are one or more DL TCI states, one or more UL TCI states, or both DL and UL TCI states.

13. The method of claim 1 wherein a Radio Network Temporary Identifier, RNTI, of the received DCI indicates whether the one or more TCI states to be activated at the WCD are one or more DL TCI states or one or more UL TCI states.

14. The method of claim 1 wherein a Radio Network Temporary Identifier, RNTI, of the received DCI indicates whether the one or more TCI states to be activated at the WCD are one or more DL TCI states, one or more UL TCI states, or both DL and UL TCI states.

15. The method of claim 1 wherein the one or more TCI states to be activated at the WCD comprises two or more DL TCI states for a single codepoint of a TCI field of DCI, two or more UL TCI states for a single codepoint of the TCI field, or both two or more DL TCI states and two or more UL TCI states for a single codepoint of the TCI field.

16. The method of claim 1 wherein the WCD maintains separate lists of activated DL and/or UL TCI states for two or more TRPs or two or more CORESET pools.

17. The method of claim 1 wherein the WCD maintains separate lists of activated DL and/or UL TCI states for two or more Synchronization Signal Blocks, SSB s, and/or Physical Cell Identifiers, PCIs.

18. (canceled)

19. (canceled)

20. A Wireless Communication Device, WCD, the WCD comprising:
one or more transmitters;
one or more receivers; and
processing circuitry, wherein the processing circuitry is configured to cause the WCD to:
receive, from a network node, downlink control information, DCI, that comprises information that indicates one or more Transmission Configuration Indicator, TCI, states to be activated at the WCD, wherein the one or more TCI states to be activated at the WCD comprise:
one or more downlink, DL, TCI states to be activated at the WCD;
one or more uplink, UL, TCI states to be activated at the WCD; or
both one or more DL TCI states to be activated at the WCD and one or more UL TCI states to be activated at the WCD; and
update a list of activated DL TCI states at the WCD, a list of activated UL TCI states at the WCD, or both the list of activated DL TCI states and the list of activated UL TCI states at the WCD based on the received DCI.

21. (canceled)

22. A method performed by a network node, the method comprising:
sending, to a wireless communication device, WCD, a downlink control information, DCI, that comprises information indicates one or more Transmission Configuration Indicator, TCI, states to be activated at the WCD, wherein the one or more TCI states to be activated at the WCD comprise:
one or more downlink, DL, TCI states to be activated at the WCD;
one or more uplink, UL, TCI states to be activated at the WCD; or
both one or more DL TCI states to be activated at the WCD and one or more UL TCI states to be activated at the WCD.

23-40. (canceled)

41. A network node, wherein the network node comprises:
one or more transmitters;
one or more receivers; and
processing circuitry, wherein the processing circuitry is configured to cause the network node to:
send, to a wireless communication device, WCD, a downlink control information, DCI, that comprises information indicates one or more Transmission Configuration Indicator, TCI, states to be activated at the WCD, wherein the one or more TCI states to be activated at the WCD comprise:
one or more downlink, DL, TCI states to be activated at the WCD;
one or more uplink, UL, TCI states to be activated at the WCD; or
both one or more DL TCI states to be activated at the WCD and one or more UL TCI states to be activated at the WCD.

42. (canceled)
